(19) United States
(12) Patent Application Publication
(10) Pub. No.: US 2014/0025839 A1
(43) Pub. Date: Jan. 23, 2014

(54) SYSTEM AND METHOD FOR INCREASING TRANSMISSION BANDWIDTH EFFICIENCY

(71) Applicant: Sirius XM Radio, Inc, New York, NY (US)

(72) Inventors: Paul Marko, Pembroke Pines, FL (US); Joseph Smallcomb, Lake Worth, FL (US); Richard Michalski, Coral Springs, FL (US)

(21) Appl. No.: 14/021,833

(22) Filed: Sep. 9, 2013

Related U.S. Application Data
(63) Continuation-in-part of application No. PCT/US2012/028637, filed on Mar. 9, 2012.
(60) Provisional application No. 61/450,840, filed on Mar. 9, 2011.

(51) Int. Cl. H04L 29/06

(52) U.S. Cl. CPC H04L 65/608
USPC 709/231

(57) ABSTRACT

Systems and methods for increasing bandwidth for digital content delivery are presented. A content delivery method and system split a digitally encoded content file (e.g., song, television show, movie, podcast, or other audio or video content file) to be delivered to receivers into at least two files with a first file being stored at a receiver in advance of receiving the second file. The first file generally includes a majority of the information in the content file but is denatured and cannot be decoded by a receiver or media player to produce even a portion of the original content file without the second file. The second file includes information derived from the original content file that is not contained in the first file. Upon receiving the transmitted second file, a receiver combines and processes both files to recover the original content file wholly or substantially for playback.

### CROSS-REFERENCE TO RELATED APPLICATIONS

This application is a continuation-in-part of PCT Patent Application No. US2012/028637, filed on Mar. 9, 2012, and published as WO 2012/122543 on Sep. 13, 2012. Additionally, priority to U.S. Provisional Patent Application Ser. No. 61/450,840, filed on Mar. 9, 2011, is claimed herein (and was claimed in PCT/US2012/028637), and that provisional application is hereby fully incorporated herein by reference. Related subject matter is disclosed and claimed in U.S. Pat. Nos. 6,834,156, 7,454,166, 7,555,020, 7,778,335 and 8,223,975, the entire contents of which are also incorporated herein by reference.

### TECHNICAL FIELD

The present invention relates to transmission of digital content to users, and in particular to systems and methods for increasing the efficiency of transmission bandwidth.

### BACKGROUND OF THE INVENTION

A number of systems exist for delivering digital content to users' receivers and other content playback devices such as satellite digital audio radio service (SDARS), other digital audio broadcast (DAB) systems or high definition (HD) radio systems, streaming content delivery systems, digital cable television systems, Direct-to-home satellite video transmission systems, and wireless data networks (3G, 4G etc.), among others.

The type of content which can be distributed in a SDARS system or other digital content delivery system can include, for example, audio programs such as music recordings, news programs and talk shows, among other programs and advertisements, but can also include video files of various lengths and types ranging from advertisements of a few seconds in duration, to short clips of the sort popular on various internet humor sites, to television programs or “webisodes”, to feature length movies. Further, the distributed content can be data files.

A significant amount of the content that is to be broadcast or otherwise delivered can be predetermined prior to transmission such as popular songs or other popular content files such as, for example, videos. Radio stations, for example, frequently use play lists to determine how often a selected number of songs, which are identified as being most popular at a given point in time, are to be broadcast. A digital broadcast, however, can also include dialogue content files from a broadcast channel host or other program host which occur between the audio programs and any advertisements presented on a broadcast channel, as well as news programs or live programming events. Popular songs and other programs which can be repeated on one or more broadcast channels, and are generally not time or date sensitive, are distinguishable from live commentary provided by a broadcast channel host, talk show host or other commentator, for example, or live programming event, or advertisements and other content that is time or date sensitive.

Since bandwidth in a digital broadcast system and other content delivery systems is typically limited and valuable, efficient use of the transmission bandwidth is desirable. This is especially the case as regards music and/or personalized music delivery systems or services which provide users' cellular phones, smartphones and other devices with a custom stream of content over wireless networks of ever changing bandwidth and conditions. A need therefore exists for a digital content delivery system wherein content is provided in a transmitted signal in an optimal manner to use transmission bandwidth as efficiently as possible.

### SUMMARY OF THE INVENTION

The above and other problems are overcome, and additional advantages are realized, by illustrative embodiments of the present invention.

In accordance with an illustrative embodiment of the present invention, a method and system are provided for improving efficiency of content transmission whereby digitally encoded content files to be transmitted are split or divided into plural parts. For example, an original content file to be broadcast or streamed to receivers in a content stream can, for example, be divided into two derived files. A first derived file can generally include a majority of the information contained in the original content file, but, as generated, the first derived file can be denatured in some way, or intentionally corrupted, and is therefore incomplete for purposes of playback. Such denaturing involves processing such that, if the denatured file were to be played, the result would be unrecognizable as the original content file, and where the sequence of bits are no longer the same or interpreted in the same way. The second derived file, can contain, for example, data missing from the first file, as well as instructions to the receiver to facilitate, inter alia, combining the two (or more) derived files. The second file can be transmitted (e.g., either broadcast or streamed via a wired or wireless internet connection, wireless network, or a dedicated fiber optic or cable connection) to the receivers. Upon receipt of the transmitted second derived file at the receiver, the first and second derived files can be combined or otherwise processed to recover (or substantially recover) the information contained in the original content file in a manner sufficient for real-time or near real-time playback, or for local storage on the receiver.

In accordance with other aspects of illustrative embodiments of the present invention, an original content file to be transmitted can be divided into at least two files. As an example, one of the files can be stored locally in or at a receiver and can be denatured so as to be unable to be played or used, and the second file can be transmitted (e.g., broadcast over the air in real-time). The first file can, for example, be loaded into the receiver when it is manufactured, or, for example, subsequently transmitted to the receiver (e.g., wirelessly transmitted or streamed via the Internet), and can, for example, be periodically updated (e.g., over the air). When the second file is delivered (e.g., broadcast to receivers), a receiver can combine the received second file with the corresponding locally stored first file to reconstruct the content (e.g., in real-time with the received broadcast) of the original file. The reconstructed content can then be consumed, for example, during playback or other content rendering application, in similar manner to content that is normally broadcast or streamed. In the absence of any ephemeral replay or storage buffers, and after any playback or content rendering has finished, only the first file will remain in the receiver. Thus, by asymmetrically splitting the content such that a larger portion of the content is provided to the receiver and a smaller portion of the content is transmitted, a significant increase in transmission bandwidth efficiency can be achieved. In the case of a SDARS or similar content provider, the second file can be part of a program content stream comprising other content. The second file can, for example, constitute about 10 percent of the file content, while the remaining 90 percent of the file content can be reconstructed using the first file which has been stored at the receivers, to significantly increase the efficiency of the transmission mode. Additionally, in exemplary embodiments of the present invention, a small amount of information can be added to the transmitted (second) file so that the receiver can reliably locate the correct stored first file (e.g., the decoder file); however, this can generally represent a trivial amount of overhead compared to the overall savings in bandwidth. For ease of description the first file, which can be stored on a receiver beforehand, will sometimes be referred to herein as a “decoder” file, and the second file, which can be transmitted as part of a broadcast or streaming service, will sometimes be referred to herein as a “broadcast” file

In another illustrative embodiment, plural decoder files can be combined into a single decoder file library. Receivers can, for example, store multiple decoder file libraries, with each decoder file in a library sharing certain common attributes, such as, for example, encoder type, encoding bitrate, and file-splitting algorithm with the other decoder files in the library. These common attributes can, for example, allow the receiver to recombine broadcast files with corresponding decoder files to reconstruct, or substantially reconstruct, the information of the content file. By combining the decoder files into libraries with common characteristics, overhead can be appreciably reduced since the common information need only be stored once. Libraries at receivers can also be modified and even customized based on user preferences.

In accordance with aspects of illustrative embodiments of the present invention, the content in the original content files can be, for example, songs or other audio files, video files of varying lengths, data files, images, electronic books, etc.

### BRIEF DESCRIPTION OF THE DRAWINGS

The present invention will be more readily understood with reference to the illustrative embodiments thereof as shown in the attached drawing figures, in which:

FIGS. 1A, 1B, 2A and 2B are block diagrams depicting encoding and splitting an original content file for efficient transmission in accordance with illustrative embodiments of the present invention;

FIGS. 3, 4 and 5 are block diagrams depicting, respectively, an encoded original content file, and first and second encoded derived files (e.g., a transmitted file and a stored file) in accordance with an illustrative embodiment of the present invention;

FIGS. 6A, 6B and 6C depict decoding and combining file segments to generate a decoded content file in accordance with illustrative embodiments of the present invention;

FIGS. 7, 8, 9 and 10 depict different types of libraries that can be employed in a receiver in accordance with various illustrative embodiments of the present invention;

FIGS. 11A, 11B, 12A, 12B, 13A and 13B depict different exemplary library operations such as adding, replacing and updating libraries at a receiver in accordance with illustrative embodiments of the present invention;

FIGS. 14A and 14B are diagrams depicting updating a library operations at a receiver in accordance with illustrative embodiments of the present invention;

FIG. 15 depicts compressed audio content being split and stored separately in two files (e.g., data tables) in accordance with an illustrative embodiment of the present invention;

FIG. 16 depicts an audio encoder output being split into two files (e.g., data tables) in accordance with an illustrative embodiment of the present invention;

FIG. 17A illustrates an encoded file having file segments in accordance with an illustrative embodiment of the present invention;

FIG. 17B illustrates the encoded file in FIG. 17A divided into first and second encoded files (e.g., a transmitted file and a stored file) each having variable size segments in accordance with an illustrative embodiment of the present invention;

FIG. 17C illustrates transmitted files having variable size segments as shown in FIG. 17B and being transmitted with overlapping segments without increasing instantaneous bandwidth in accordance with an illustrative embodiment of the present invention;

FIG. 18 depicts an illustrative content delivery system;

FIG. 19 depicts an illustrative content stream;

FIG. 20 depicts a content receiver in accordance with an illustrative embodiment of the present invention;

FIG. 21 depicts a compressed song structure in accordance with an illustrative embodiment of the present invention;

FIG. 22 depicts compressed content packet being split and stored separately in a broadcast or transmitted file (e.g., Tx Data Table) and a local stored file (e.g., Rx Data Table) in accordance with an illustrative embodiment of the present invention;

FIG. 23 depicts combining the broadcast Tx Data Table and the local Rx Data Table of FIG. 22 in accordance with an illustrative embodiment of the present invention;

FIG. 24 depicts instantaneous bandwidth usage for an Enhanced Broadcast Technology (EBT) Channel in accordance with an illustrative embodiment of the present invention;

FIG. 25 depicts a broadcast bandwidth profile for short duration EBT Channels in accordance with an illustrative embodiment of the present invention;

FIG. 26 depicts a mixed EBT Channel service configuration in accordance with an illustrative embodiment of the present invention;

FIG. 27 depicts bandwidth allocation for an EBT streaming service (e.g., a 3.0 kbps transmission channel allowing for simultaneous live music, library updates and interstitial content insertion) in accordance with an illustrative embodiment of the present invention;

FIG. 28A is a plot of amplitude vs. time for an illustrative original audio content file comprising a portion of a song;

FIG. 28B is a plot of amplitude vs. frequency for the illustrative original audio content file depicted in FIG. 28A;

FIG. 29A is a plot of amplitude vs. time for an illustrative EBT file (e.g., a DTF) derived using the methods of the present invention to process the original audio content file depicted in FIG. 28A;

FIG. 29B is a plot of amplitude vs. frequency for the illustrative EBT file depicted in FIG. 29A;

FIG. 30 illustrates fading profiles for use with cross-fades and/or fade-ins and fade-outs between two audio clips according to exemplary embodiments of the present invention;

FIGS. 31-34 illustrate exemplary library formats, packet structures, and stream protocols that may be used for Broadcast Track Libraries, Decoder Table Libraries, and EBT packets in various exemplary embodiments of the present invention;

FIG. 35 illustrates an exemplary decoder process according to an exemplary embodiment of the present invention; and

FIG. 36 illustrates cross-fading options and splitting of long tracks, according to various exemplary embodiments of the present invention.

Throughout the drawing figures, like reference numbers will be understood to refer to like elements, features and structures.

### DETAILED DESCRIPTION OF THE INVENTION

### Overview: Increasing Efficiency of Content Delivery Transmission Bandwidth

In exemplary embodiments of the present invention, the efficiency of transmission bandwidth can be increased by splitting a digitally encoded, original content file to be transmitted into least two derived files, tables or other data structures or groupings. As an example, one of two files, which can include a majority of the original content file, can be stored locally in a receiver. The second derived file can be transmitted (e.g., broadcast over the air in real-time or streamed) to a receiver. For example, the first file can be loaded into the receiver when it is manufactured, or it can be subsequently transmitted to the receiver (e.g., wirelessly transmitted or streamed via the Internet) and periodically updated. In accordance with illustrative embodiments of the present invention, the first file is generally available at the receiver prior to the receiver's receipt of the second file.

Once the second file is delivered (e.g., broadcast or streamed to one or more receivers), a receiver combines the second file with the locally stored first file to reconstruct, or substantially reconstruct, the information of the original content file (e.g., in real-time with the received broadcast). For example, the encoded content can be reconstructed by inserting missing data segments received over the air (e.g., the second file) into the locally stored first file or by using intelligent algorithms to otherwise combine the segments received over the air with the locally stored first file segments. Upon consumption of the combined segments, the second file segments are no longer available in the receiver, whereas the first file segments remain in local storage (albeit denatured and effectively unusable to varying degrees), as described in more detail below.

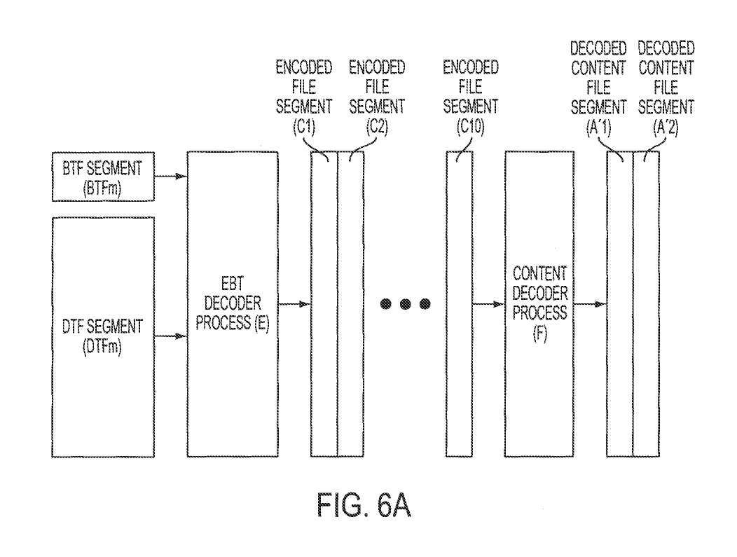

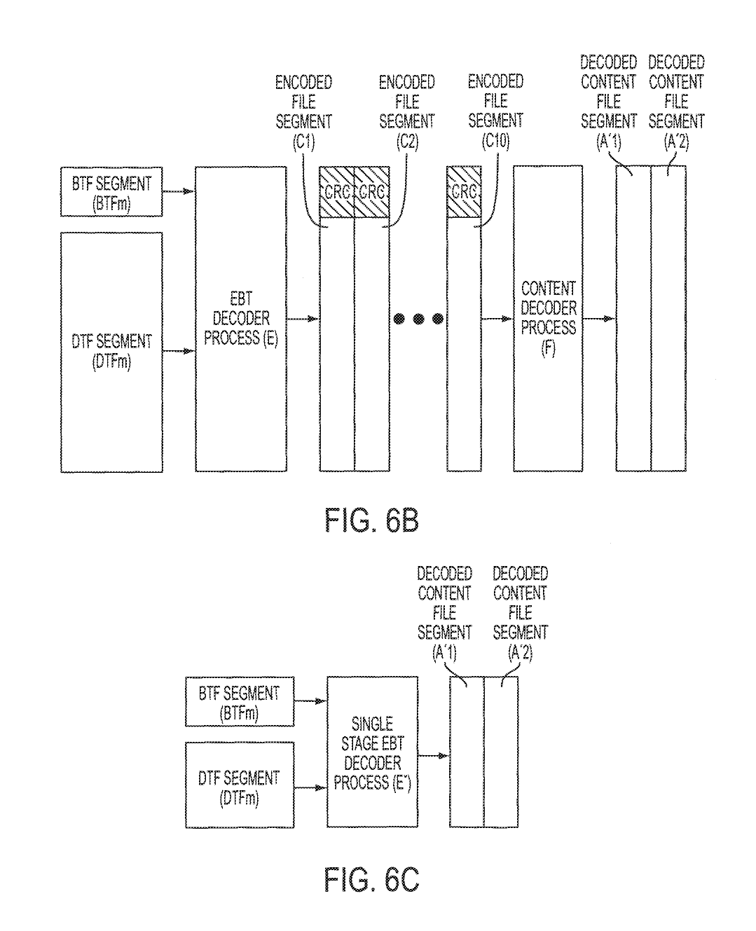

As explained below, the first file can be denatured such that no segment of it relates to any portion of the corresponding encoded original content file. To create the first and second files, the original content file can be encoded, and the encoded file then split into at least two files using various algorithms, where bits or groups of bits can be removed from the encoded original content file to create the second file. The remaining compressed data can be used to create the first file. In illustrative embodiments of the present invention, the split can be implemented so that the first file no longer contains any of the structure or framing information for packets or frames of the original encoded content file that serve to identify bit positions for the encoded data, or even any reference to the encoded file packets or frames. In such embodiments, the bits in the first file are thus essentially random (i.e., generally not in the same or similar sequence as the encoded content file) and unrecognizable with respect to the encoded original content file without using the data from the transmitted second file and having knowledge of the process or algorithm(s) that were used to perform the split. This latter knowledge can be provided to the receiver by way of a split file decoding process, shown, for example, as “EBT Decoder Process (E)” in FIG. 6A.

Split file decoding reconstructs the encoded original content file from the received second file by first locating its corresponding stored first file and combining the first and second files. The combined or reconstructed encoded file, or encoded file segments, can then be subject to content file decoding using a technique corresponding to the encoding technique employed by the encoder. Thus, instead of simply encrypting an original content file such that all of its content remains present (i.e., in an encrypted form) in the receiver or receiving device, part of the actual content has been removed from the stored file, and the reconstitution process requires that missing content to be replaced. In accordance with illustrative embodiments of the present invention, the denatured first file cannot be decrypted. Thus, any attempt to recover the original content without the second file requires guessing at what information is missing, as well as where it belongs in relation to the other information, and is therefore qualitatively more complex than, for example, guessing at a decryption key. Further, the transmitted second file is not a key, but rather contains additional information derived from the encoded content file that was excluded from the stored first file.

In exemplary embodiments of the present invention, a significant increase in transmission bandwidth efficiency can be achieved by asymmetrically splitting the content file such that a larger portion of the content is pre-provided to the receiver (e.g., via the first file) and a lesser portion of the content is transmitted (e.g., via the second file). For example, if the ratio of the size of a locally stored file to a broadcast file is greater than 10:1, then an increase in broadcast efficiency is achieved of at least 10 times greater than the bandwidth efficiency of transmitting a full copy of content file even as compressed. Since the locally stored file is a denatured file that does not contain sufficient information to replay all or even part of the original content file, and its segments do not relate to any portion of the encoded content file without first combining with the transmitted file, the first file (e.g., a local file) cannot be decoded without the use of the transmitted file. Instead, the locally stored first file can be characterized as a custom file table database for the audio (or video) decoder, similar to the Huffman Coding tables stored in the receiver 14, for example. In this respect, the first file table can be seen as a highly compressed version of the original content file that has been denatured such that none of its segments relate to any portion of the content file when decoded by itself and without reconstruction using the transmitted second file. With the exception of the file combining process, the second file table is handled at the receiver in a manner equivalent to a normally compressed original content file in that only the file portions required for normal receiver operations (e.g., content rendering or playback) are retained in RAM.

### Enhanced Bandwidth Technology (EBT) Files and Libraries

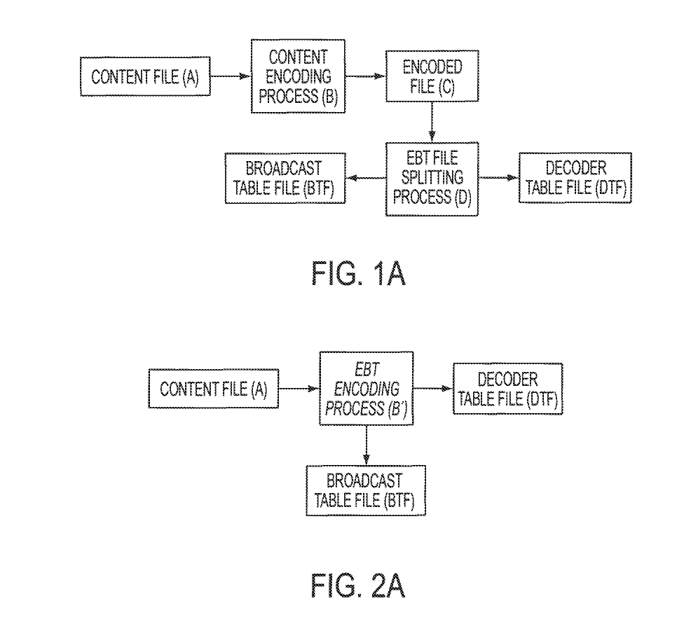

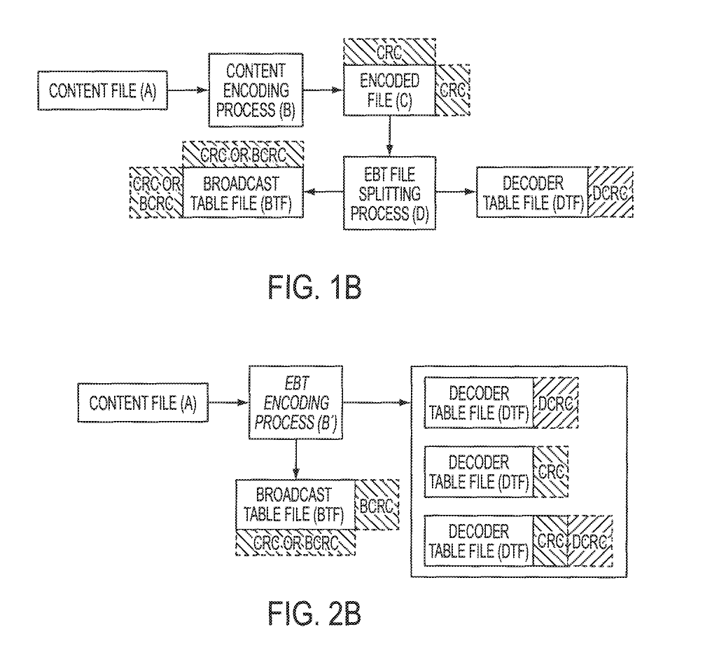

The content delivery approach will now be exemplified with reference to FIGS. 1-6 and in accordance with illustrative embodiments of the present invention. By way of example, the following terms shall be used:

Content File: the original information to be made available to a user such as audio content, video content, data, etc. The term “file” is understood to be very general. Thus a table or other grouping of data or data structure can be a type of file. As explained below, and as referred to in the figures, different types of table files can be used (e.g., a Broadcast Table File and a Decoder Table File).

Encoded Content File: the Content File after being encoded. For audio content, an audio encoder can be used that employs USAC, AAC, Mp3, or PAC, among other coding methods. For video content, a video encoder can be used that employs MPEG-4, WMV, AVC/H.264, or DVB-S2, among other coding methods. For static images, an image encoder can be used that employs JPEG, PNG, or GIF, among other coding methods. For data, an entropy coding technique (e.g., ZIP) can be used.

Encoded File Segment: the smallest portion of an encoded file that can be decoded by a suitable decoder into a format resembling the original content such as an “audio frame” or a “video frame.” File segments can vary in length.

Enhanced Bandwidth Technology (EBT): content encoding and corresponding decoding wherein a Content File that has been encoded is split into at least two parts hereinafter referred to as “EBT files” in accordance with illustrative embodiments of the present invention. As noted above, at least one of the EBT files is provided to a receiver(s) in advance of its receiving the transmitted EBT file and another is transmitted.

Broadcast Table File: one of at least two EBT files. The Broadcast Table File (BTF) is transmitted (e.g., broadcast or streamed) in real-time or near real-time and is typically the smaller of the two files.

Decoder Table File: one of at least two EBT files. The Decoder Table File (DTF) is stored locally in the EBT receiver in advance of the real-time transmission of the BTF, and is used to decode the Broadcast Table File (BTF). The Decoder Table File (DTF) is typically the larger of the two files so as to improve transmission bandwidth efficiency of the BTF.

BTF and DTF segments: the smallest fragment of a BTF or DTF which contains the information necessary for decoding in accordance with illustrative embodiments of the present invention. The BTF segments and DTF segments have a one to one correspondence with each other. The BTF and DTF segments do not necessarily have a one-to-one correspondence with Encoded File Segments. For example, the combination of a single audio DTF segment and its corresponding BTF segment (i.e., one EBT audio segment) can correspond, for example, to 9 or 10 encoded audio frames.

Decoded Content File: the file that results from decoding an Encoded Content File. In some special cases (e.g., lossless encoding), the Decoded Content File is identical to the original Content File. However, in the more general case, the Decoded Content File is merely similar to the original content file. In other words, for the case of an original Content File consisting of audio, the Decoded Content File can be an audio file that sounds, to varying degrees, like the original content when played for a user. If the original content file were a video, the resulting Decoded Content File can be a video file that looks like, to varying degrees, the original Content File when viewed by a user.

Reconstructed Content File—an Encoded Content File created by combining the two EBT files at a receiver, or by combining a series of BTF and DTF segments at a receiver.

With reference to FIG. 1A, a Content File (A) is shown that is encoded via Content Encoding Process (B) in accordance with an illustrative embodiment of the present invention. The Content File (A) can be uncompressed audio, video, image, text, data or some other type of content. Encoding Process (B) can be, for example, AAC+, USAC, PAC, MPEG-4, AVC/H.264, entropy encoding (e.g., ZIP) or other encoding technology. Encoded File (C) that is output from Encoding Process (B), can be decoded to produce an output file (A′) as described below with reference to FIG. 6A, where A′ is either identical to (i.e., in the case of lossless compression) or substantially similar to (e.g., in the case of lossy compression) the original Content File (A).

With continued reference to FIG. 1A and in accordance with an illustrative embodiment of the present invention, software process EBT File Splitting Process (D) can, for example, split Encoded File (C) into at least two separate files. For illustrative purposes, the two files are respectively referred to as a Decoder Table File (DTF) and a Broadcast Table File (BTF). As stated above, Encoded File (C) can, for example, be divided into two or more parts that can be different types of data structures. Thus, for each Encoded File (C), a corresponding DTF and BTF are derived and assigned an identifier, tag, or index to facilitate matching a BTF with its corresponding stored DTF when the BTF is received. The identifier (e.g., file ID) can be the same as between the BTF and its corresponding DTF. Alternatively, if different indicia or tags are used as nomenclature for the corresponding BTF and DTF, then the receiver and/or the stream can be provided with a map, table or algorithm for facilitating the location of a stored DTF when its corresponding BTF is received.

Alternatively, and with reference to FIG. 2A, content encoding EBT Encoding Process (B′) can involve encoding Content File (A) and splitting the output in a single step. Thus, EBT Encoding Process (B′) can, for example, produce two files (Decoder Table File (DTF) and Broadcast Table File (BTF)) which can be combined to produce an output file (A′) at the receiver as described below in connection with FIG. 6C.

EBT Encoding Process (B′) described herein creates first files (i.e., denatured, stored files) that are uniquely designed for individual pieces of content to achieve high efficiency (e.g., high levels of compression) in a broadcast or other transmission stream. Thus, rather than a decoder table that is optimized for “music” or “talk,” for example, an EBT decoder table file can be, for example, optimized for a particular specific piece of content. In accordance with illustrative embodiments of the present invention, the degree of denaturing, which is a function of the EBT File Splitting Process (D) in FIGS. 1A and 1B, and the EBT Encoding Process (B) in FIGS. 2A and 2B, can vary from slightly denatured, not denatured at all, to fully denatured, and can therefore be a design parameter. While other compression techniques can be altered or fine-tuned to work with certain pieces of content, existing compression schemes do not generate a decoder table for each piece of content as does EBT. While a given Decoder Table File (DTF) and corresponding Broadcast Table File (BTF) can be approximately the same size, in exemplary embodiments of the present invention, Content File (A) can, for example, generally be divided asymmetrically. For example, a Decoder Table File (DTF) can be much larger than its corresponding Broadcast Table File (BTF) to optimize bandwidth efficiency. Thus, the Broadcast Table File (BTF) can be a file containing only a small portion of the information contained in Encoded File (C), and can be combined with a corresponding Decoder Table File (DTF) to reproduce output file (A′). Thus, a Decoder Table File (DTF) can be a denatured file with respect to the Encoded File (C) that contains a majority of the information required to reconstruct the Encoded File (C). If an attempt is made to decode the DTF without using the information contained in the corresponding Broadcast Table File (BTF), the decoded DTF will either (i) not play at all (e.g., no sounds or display); (ii) provide random unrecognizable sounds, in the case of one or more audio content file segments; or (iii) display mere pixelations, in the case of one or more video content file segments which bear no relation to the Encoded File (C) or even parts of the Encoded File (C).

Because the Encoded File (C) is compressed, it is more subject to small data errors. In other words, even small data errors can result in large perceived changes in the quality of the decoded file. Some encoding processes add a Cyclical Redundancy Checksum (CRC) to the entire Encoded File (C), or, for example, to encoded packets or segments within the Encoded File. Both types of CRC placements are illustrated with respect to the Encoded File (C) in FIG. 1B. Encoding with a CRC allows decoding devices to detect errors in files or segments and either not process them, or alternatively, replace them with computed or averaged packets intended to conceal errors from listeners.

Since a CRC provides information about missing or erroneous bits, it can be important to the security of an EBT implementation to strip CRC data, if present, from the Encoded File (C) altogether and not place it the stored file (i.e., the DTF); otherwise, the CRC data could be used to facilitate an attempt to reconstruct the DTF. Ensuring that the DTF does not contain the CRC or any part of the CRC makes reconstruction of the Encoded File (C) without the BTF much more difficult; therefore, higher ratios of compression (e.g., larger ratios of DTFs to DTFs) are possible. Alternatively, as described below in connection with FIGS. 1B and 2B, CRC data can be placed in one or both EBT files in accordance with other optional illustrative embodiments of the present invention, depending on the degree of security desired for different EBT implementations.

FIG. 1B depicts dual stage EBT encoding with CRC. As stated above, a Cyclical Redundancy Checksum (CRC) for an entire Encoded File (C) is produced as part of the output in some encoding processes, enabling a suitable decoder to produce an acceptable decoded file even with some errors present in the encoded file. In other implementations of encoding processes, however, a Cyclical Redundancy Checksum (CRC) for individual portions or segments of Encoded File (C) is produced as part of the output. In accordance with an illustrative method of file splitting encoded files containing a CRC, the CRC for the Encoded File (C) (or for portions thereof) can, for example, be removed so that they are not present in the DTF. This method can be advantageous since this portion of the Encoded File (C) could theoretically provide some information about the missing data in the BTF. In alternate exemplary embodiments, an optional Broadcast CRC (BCRC) or the CRC for a combined BTF and DTF can be added to each segment of the BTF or to the entire BTF. In yet other alternate exemplary embodiments, a new CRC that applies only to the information contained in the DTF can, for example, be added to the DTF during the EBT File Splitting Process (D), so that errors in the DTF itself can be detected and/or corrected. As noted, a less secure alternate method could include the Combined CRC in the DTF.

FIG. 2B illustrates single stage EBT encoding where a modified content encoding process (B′) encodes Content File (A) and splits the now encoded output in a single step. As shown, in accordance with an illustrative embodiment of the present invention, the single-stage EBT Encoder (B′) can create an optional CRC for the DTF (i.e., a DCRC) to ensure that the DTF is correctly copied into a receiver without errors. In accordance with an alternative illustrative embodiment, the EBT Encoding Process (B′) could, for example, include an optional CRC for the combined or EBT decoded file. This option, however, is less secure than an embodiment wherein the CRC is removed, or only a DCRC is used. In accordance with another alternate illustrative embodiment, EBT Encoding Process (B′) can, for example, include both an optional CRC for the combined file, and a separate DCRC that can only detect and/or correct errors in the DTF. Similarly, in accordance with yet other alternate implementations, Encoding Process (B′) can produce a CRC for the combined EBT decoded file, for the BFT alone, or for both.

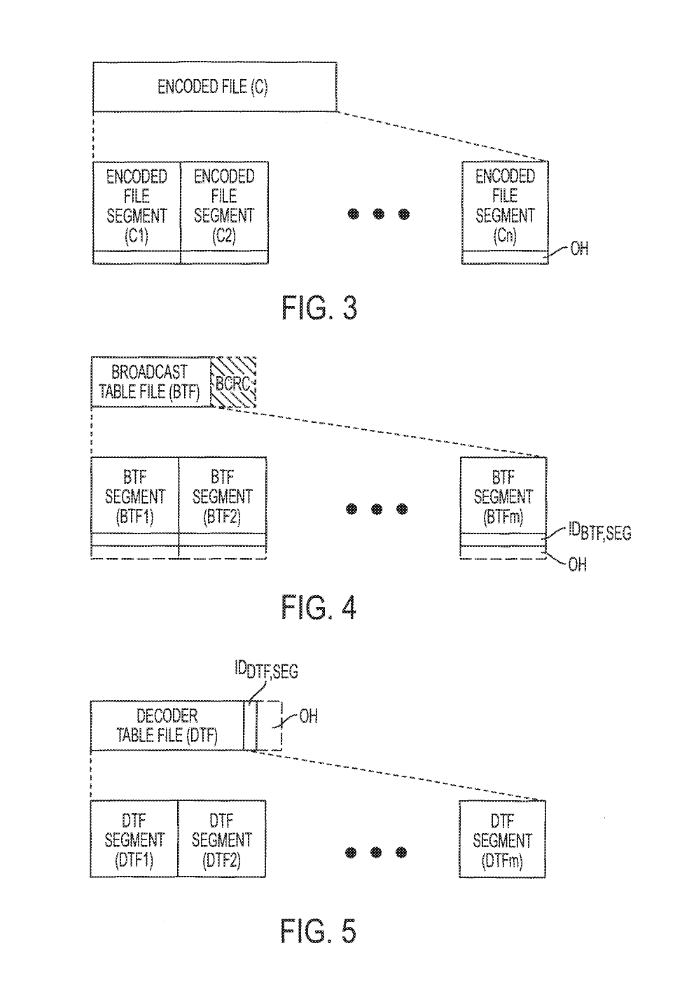

With reference to FIG. 3, an encoded file can be encoded using, for example, AAC+, MP3, USAC, JPEG, MPEG-2, Huffyuv, x264, Quicktime AVC/H.264, DVB-S2, MPEG-4, Windows Media Video (WMV), VP6, VP8, entropy encoding, among other techniques. The encoded file can, for example, comprise a number of “segments” (e.g., C1, C2, . . . , Cn), with each segment Cn containing all of the information required for a suitably designed decoder to reproduce the corresponding original content, or a close approximation of the corresponding original content, that is substantially similar to the original content. In the example of audio content, a segment can be, for example, an “audio frame.” Part of Encoded File Segment Cn is “overhead” or OH, which can include, for example, information about the encoding technique and data rate. This information is necessary for the decoder at the receiver to correctly interpret Encoded File Segment Cn.

As noted, a Broadcast Table File (BTF) can be the smaller of two files resulting from the encoding and file splitting process. With reference to FIG. 4, a BTF comprises a number of segments (e.g., BTF1, BTF2, . . . , BTFn), where each segment can, for example, correspond to one or more of the segments of original Content File (A). Where a BTF segment corresponds to more than one content segment, a BTF identifier and a segment ID, ID_{BTF,SEG}, can be transmitted in each BTF segment to enable a receiver to determine the correct DTF segment to use in decoding the BTF segment. In one implementation, it is possible to include information about encoding and additional information about file splitting in every BTF segment. However, if BTFs are much smaller than Encoded Files, this can be inefficient. An alternative implementation is described below in connection with FIG. 5. It is noted that the use of BTF segments and corresponding DTF segments to represent more than one original content segment further illustrates the extent to which the DTF is denatured. This is because combining multiple denatured segments further obscures original content segment boundaries than if there remained a one to one mapping of DTF segments to original Content File (A) segments.

With reference to FIG. 5, the DTF can be the larger of the two EBT files. The DTF contains a number of segments, where each segment can correspond to a BTF segment. The DTF is stored at a receiver with information (e.g., ID_{DTF,SEG}) that allows the receiver to locate specific segments within a DTF. In a more efficient implementation than that depicted in FIG. 4, OH information can be provided once for the entire DTF. Since the entire DTF is pre-stored in the receiver, information common to all segments in the file needs to be stored only once per file.

Operations at a receiver to combine locally stored DTF segments with transmitted and received BTF segments are next described with reference to FIG. 6A. As stated above, in general a DTF segment does not contain any complete Encoded File Segments. An EBT Decoder Process (E) (which can be, for example, resident on an EBT decoder within the receiver) can combine a BTF Segment with a corresponding DTF segment to produce an output of one or more Encoded File Segments Cn such as, for example, C1, C2, C3, . . . C10, as shown, where each BTF/DTF combination produces 10 encoded content segments. A Content Decoder Process (F) (which can be, for example, resident on a standard decoder within the receiver) can decode Encoded File Segments Cn, to undo the Content Encoding Process (B, B′) in FIGS. 1A and 2A. Decoded Content File Segments (A′1, A′2, . . . , A′n) are either identical to, or are substantially similar to, original Content File Segments (A1, A2, . . . , An) (not shown) of Content File (A) (FIGS. 1-2). As known, for lossless encoding, A′1=A1, and for lossy encoding schemes, such as USAC, AAC, MPEG-4 etc., A′1 will sound or look similar to the original content A1 when played or displayed to a user.

FIG. 6B illustrates EBT Decoding (E) where an encoder has included a CRC in each Encoded File Segment (Cn). In exemplary embodiments of the present invention, neither the DTF nor any DTF segments can contain any CRCs, in which case EBT Decoder Process (E) constructs the CRC values during the combining process. In a single-stage EBT Decoding Process (E′) as illustrated in FIG. 6C, the BTF segments and DTF segments are combined and the resulting combined file is decoded to produce Decoded File Segments (A′n) in a single step. In such an exemplary embodiment, it is not necessary to produce the CRC for the Encoded File Segments.

A transmitted stream can, for example, use information or metadata to instruct a receiver(s) on which DTF to combine with a particular BTF for decoding as per an EBT Decoder Process. Uncertainty, however, can occur when decoding. For example, if DTFs are broadcast to receiver(s) as opposed to streaming DTFs (e.g., a receiver must be powered on for a selected amount of time over a selected broadcast period to receive transmitted DTF updates), uncertainty exists as to whether the receiver actually received the necessary DTF to decode a given BTF. Use of libraries or collections of files in accordance with illustrative embodiments of the present invention can overcome such uncertainty and realize a number of advantages. For example, a library can be a structured group of files, or the files in a library can, but are not required to, share some common characteristics. In another example, multiple DTFs can be combined into a decoder table file library stored at the receiver. As described in more detail below, metadata can be transmitted to receiver(s) to indicate that a particular program channel uses a particular library (e.g., a map or table can be transmitted that relates the channel numbers or indices of EBT channels to a decoder file library or set of libraries required to process the content on that channel). Storage of that library at a receiver(s) facilitates determination by the receiver of whether it can play that program channel when transmitted using EBT files. The metadata can also be pre-programmed into the radio. If the receiver cannot locate the particular DTF needed to playback a currently tuned channel, it can, for example, be configured to playback silence for an audio channel and display a message that content is unavailable and an optional reminder to update the library for that channel.

In exemplary embodiments of the present invention, libraries of DTFs are also advantageous in that they can indicate encoder properties used to create the corresponding BTFs. It is to be understood, however, that other methods can be used to communicate encoder properties to receivers. For example, as explained above, a transmitted EBT file, i.e., a BTF, can optionally include information about encoder properties. Alternatively, messaging can be used, although it is not as efficient in terms of bandwidth. For example, message bits can be sent with a code indicating how a receiver should combine transmitted file bits in a BTF with stored file bits in a DTF.

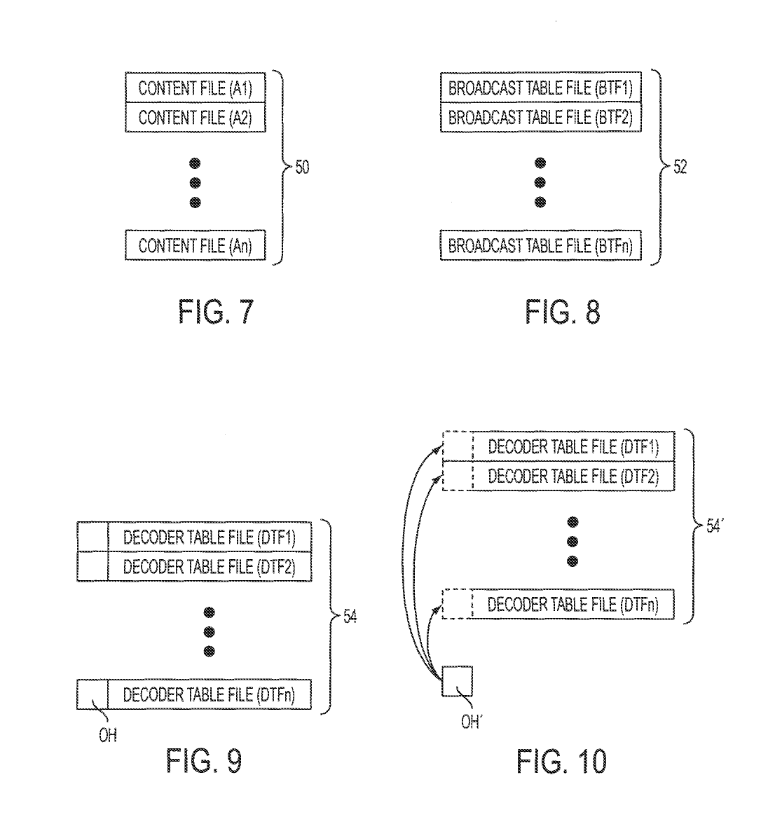

With reference to FIG. 7, a content provider, programming center, broadcaster or other source can create a Content File library 50, which can be a group of Content Files that make up a collection or “library” of Content. Content File library 50 can, for example, be a collection of audio files, video files, images, or arbitrary data files, or a mix of several different types of content. With reference to FIG. 8, a corresponding BTF library 52 can be created comprising a group of BTFs making up a collection or “library” of BTFs. The BTF library 52 can be used to construct a stream or “channel” by transmitting a sequence of files from the library to an EBT-capable receiving device having a corresponding DTF library. As shown in FIGS. 9 and 10, a DTF library can be, for example, either a mixed encoder DTF library 54 (FIG. 9) or a single encoder DTF library 54′ (FIG. 10).

With reference to FIG. 9, in mixed Encoder DTF library 54 each file has unique encoder properties. In one illustrative implementation, each decoder file has encoding and file splitting information stored with it as a header or wrapper of the DTF, indicated generally at OH. This implementation can be advantageous for EBT encoding of heterogeneous collections of dissimilar content files (e.g., two or more of images, audio files, video files, data, and so on).

With reference to FIG. 10, a single-encoder DTF library 54′ comprises a group of DTFs where all of the files share common attributes (such as, for example, all are audio files encoded with USAC codec). In another example implementation, for multiple DTFs having common encoding and file splitting information, the information could be stored once for an entire group of DTFs as indicated at OH′ rather than in each individual DTF as illustrated in FIG. 9, thereby saving memory.

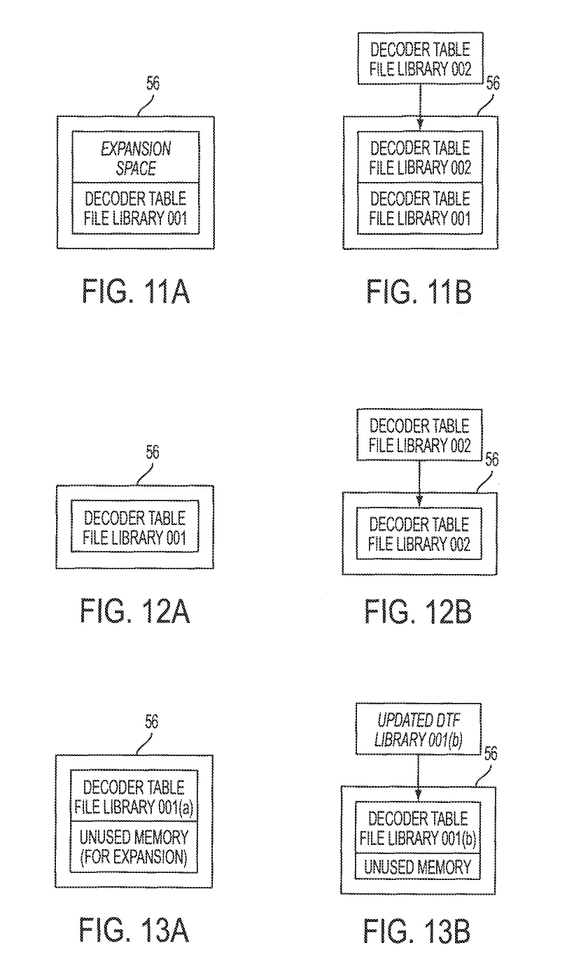

Maintaining libraries at EBT-capable receivers will be now described with reference to FIGS. 11-13 in accordance with illustrative embodiments of the present invention. When providing EBT files, or libraries of files, to be stored at receiver(s), instructions can also be provided to the receiver(s) to indicate whether the EBT files (e.g., DTFs) or libraries are to be added to the receiver's stored files, or whether they are to replace selected stored files or libraries, or whether a updated library is being provided, in which case a receiver compares the updated library with the corresponding stored library and adds, replaces and/or deletes files in the library as needed. These instructions can be included as part of the files or libraries (e.g., in a header or wrapper) when transmitted to the receiver for storage, or via separate messaging or metadata in a transmission channel used to transmit the files or libraries.

With reference to FIG. 11A, memory 56 in a receiver can be provided with one or more libraries (e.g., DTF Library 001) with expansion space. New DTF libraries can thus be added to receiver memory 56. As shown in FIG. 11B, the entire contents of DTF Library 002 can be sent to the receiver and stored in memory 56. The receiver device now has two Libraries, that is, the original one (DTF Library 001) and a new one (DTF Library 002).

Alternatively, DTF libraries can be replaced as well as added. FIG. 12A depicts a receiver memory 56 storing DTF Library 001. As shown in FIG. 12B, the entire contents of DTF Library 002 can be sent to the receiver, and the receiver can replace one DTF Library (i.e., DTF Library 001) with another (i.e., DTF Library 002) which may have completely different files.

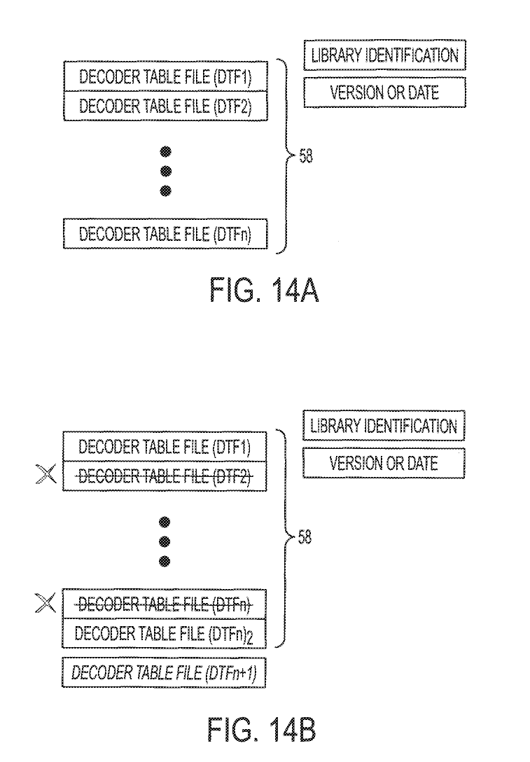

DTF libraries can also be updated. As shown in FIG. 13B, an updated library DTF Library 001(b) is provided to update DTF Library 001(a) shown in FIG. 13A. Updateable Libraries can be provided with a version number, date or unique ID. New DTFs in an updateable library can thus replace or augment existing DTFs in earlier versions of the libraries, while files in the earlier versions of the libraries that are no longer included in the updatable library can be deleted. Thus, in various exemplary embodiments, an updated library can have more files and therefore require additional memory 56, or can have fewer files and therefore require less memory 56. With continued reference to FIG. 13B, the receiver can receive the updated library (e.g., DTF Library 001(b)) via a transmission channel (e.g., broadcast, streaming, etc.), via a memory stick, or downloading, for example. Similarly, the receiver can replace one or more DTFs with another DTF while leaving other DTFs unchanged. The version or date of the library can, for example, then be changed, but the library ID is generally not changed.

For illustrative purposes, a group of DTFs 58 that constitute a collection or library of EBT files (e.g., DTFs) for storage in a receiver memory 56 is shown in FIGS. 14A and 14B. Library 58 can be a single or mixed encoder DTF library, for example. Library 58 can have a unique identifier associated with it to allow for updates, and, as stated above, can have a version and/or date associated with it if it is an updatable library. Updating a library 58 requires sending only the changes or updates and not the part of the content that is unchanged, which can constitute most of the library's contents, thereby improving bandwidth efficiency. As shown in FIG. 14B, most DTFs are often unchanged during a library update. DTFs can be deleted (e.g., DTF2) to make room for additions, in which case that particular DTF index will not be used, for example. DTFs can also be replaced, whereby the old one (e.g., DTFn) can be removed and the new one having the same “index” but different content (e.g., [DTFn]₂) can be added. Further, Library 58 can be expanded whereby new DTFs (e.g., DTFn+1) can be added.

As stated above, library and file indices can be embedded in the stored files (e.g., EBT files for storage at the receiver such as DTFs or libraries or collections of files for storage). Alternatively, library and file indices can be added as a wrapper at the time of transmission of the stored files so that the appropriate stored files, DTFs, can be located by the receiver and combined with the transmitted EBT files, BTFs, in real-time. As stated above, indexing and tagging the files within a decoder table file library or collection 58 can also be employed so that the transmitted EBT files and the stored EBT files, or portions of these files (e.g., segments as shown in FIGS. 4 and 5) can be reliably matched. Indexing decoder file libraries or collections themselves also simplifies instructions to the receiver to maintain current libraries or collections of stored EBT files by adding or replacing files or updating libraries.

The EBT files or libraries for storage at the receiver can be embedded with encoding and file splitting information or parameters such as the type of audio or video encoder used and the encoded bit rate in the stored files or the algorithm or technique for providing missing bits from a transmitted file or file segment to a stored file or file segment. As stated above, the embedded information simplifies the determination by the receiver of the processes needed for EBT decoding (e.g., via EBT Decoder Process (E) in FIG. 6A). DTFs in a library, for example, can have a similar pattern or algorithm used to combine the DTFs with BTFs. Thus, libraries can eliminate the need to repeat for each BTF or DTF the information needed to resolve the DTF with the corresponding BTF provided that the DTF is part of a library and that the library is referenced in some manner. In accordance with one example, a library can comprise DTFs that correspond to the audio frames of a selection of 4000 songs or tracks, and a broadcast or streamed EBT channel can be created to play songs from such a library. The receiver can be configured, when the library is loaded into its memory or when the DTFs are received, to use that library when tuned to a particular channel to determine how to combine received BTFs for that channel with the correct corresponding DTFs to decode the original content. As described below, interstitial content such as disk jockey (DJ) commentary can be transmitted in real-time in addition to the BTFs so as to create a true radio program experience for listeners of such streamed channels.

### Illustrative Methods for Generating EBT Files

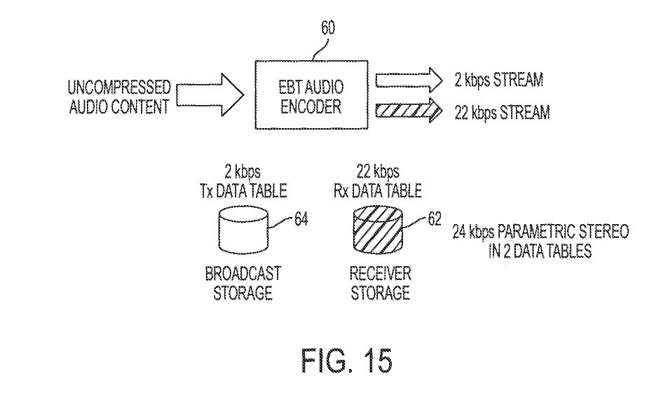

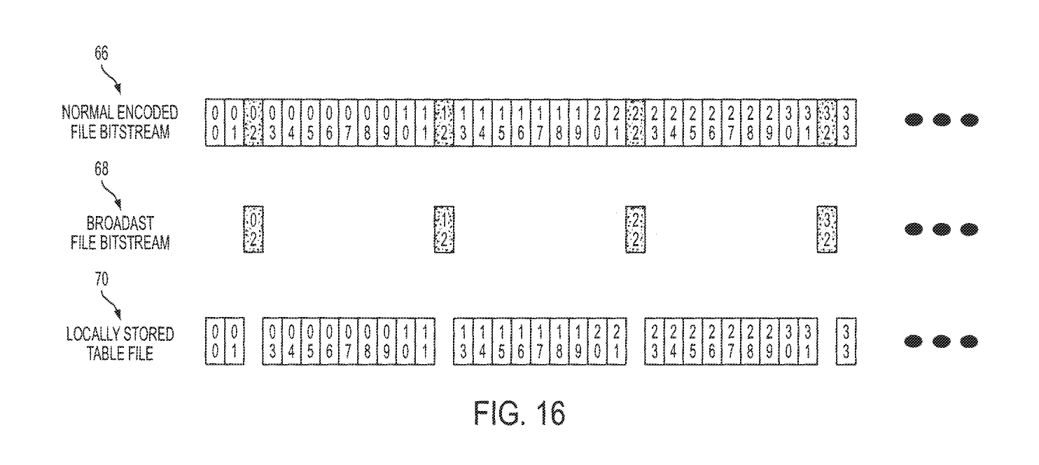

As stated above, a content delivery approach is provided to increase the efficiency of transmission bandwidth by splitting an original content file to be transmitted into at least two files, tables or other data structures or groupings (e.g., EBT files), in accordance with exemplary embodiments of the present invention. As stated above, at least one of the EBT files can be transmitted in real-time or near-real time. At least one other EBT file can be generated and provided to receiver(s), for example previous to the transmitted file and then pre-stored, for combining with the transmitted EBT file to generate a decoded content file. The original content file can, for example, be split such that the EBT file stored at the receiver(s) is denatured and either cannot be decoded for play back to a user (i.e., without data from the transmitted EBT file), or plays back decoded sounds or pixelations bearing no resemblance to the original content file. Examples of different approaches for splitting the content file are next described with reference to FIGS. 15-16.

With reference to FIG. 15, a first illustrative approach for splitting an original content file to be broadcast or otherwise transmitted into two file tables involves an EBT Audio Encoder 60 designed to output two streams. This approach can be achieved, for example, within the audio encoder transport operations at a programming center or other location where content is prepared for transmission. In one example, for a 24 kilobits per second (kbps) output stream, the EBT Audio Encoder 60 can output a first stream at 22 kbps, which can be stored in a corresponding receive data table file 62 at a receiver(s), and a second stream at 2 kbps which is prepared for broadcast or other mode of transmission to the receiver(s) as indicated by the transmit data table file 64. A receiver, in turn, can apply the received transmitted stream to a corresponding audio decoder, along with the data from the 22 kbps locally stored Rx data table file 62 (e.g., in its Flash or other memory), and then reassemble the two files in the audio decoder to properly decode the transmitted stream. In this example, bandwidth efficiency can be improved by at least 90% by splitting the original content into the EBT files

A second illustrative approach for splitting content files is independent of the audio transcoder transport and uses secret sharing techniques. For example, an output of an audio encoder (e.g., at a programming center or other location where content is prepared for transmission) can be, for example, split into two asymmetrical tables. Assume the following binary coefficient matrix is applied to a content file X comprising 5 file segments [X1 X2 . . . X5] and generates polynomial product symbols [S1 S2 . . . S5]:

$$\begin{matrix}1 & 1 & 1 & 1 & 1 \\ 1 & 1 & 0 & 0 & 0 \\ 0 & 1 & 1 & 0 & 0 \\ 0 & 0 & 1 & 1 & 0 \\ 0 & 0 & 0 & 1 & 1\end{matrix} * \begin{matrix}X 1 \\ X 2 \\ X 3 \\ X 4 \\ X 5\end{matrix} = \begin{matrix}S 1 \\ S 2 \\ S 3 \\ S 4 \\ S 5\end{matrix}$$

Bold symbol S1 can be broadcast over the air or otherwise transmitted (BTF), and the remaining symbols can be stored locally at the receiver(s) (DTF). The polynomial product symbols [S2 . . . S5] are thus cached at the receiver(s), but cannot be decoded without receiving the bold symbol S1. Once the bold symbol is received, and file segment X1 is decoded, the remaining file segments [X2 . . . X5] can be decoded by the receiver(s).

In this example, [X2 . . . X5] are differentially encoded file segments, so a differential decoder is used to retrieve the remaining encoded file segments.

### X1=S1*S3*S5

### X2=S2*×1

### X3=S3*×2

### X4=S4*×3

### X5=S5*×4

In accordance with another illustrative embodiment of the present invention, a third approach can be used which is also independent of the audio transcoder transport. Data from the audio encoder output can, for example, be split into two separate tables, or other types of data structure, to generate the at least two EBT files. As shown in FIG. 16, a normal encoded file bitstream 66 can be split into a broadcast file bitstream 68 and a locally stored file 70 (e.g., table file) by extracting certain number of bits at defined intervals. The symbols in this approach can, for example, be bits, bytes or special data blocks (e.g., MSBs of the L+R data fields).

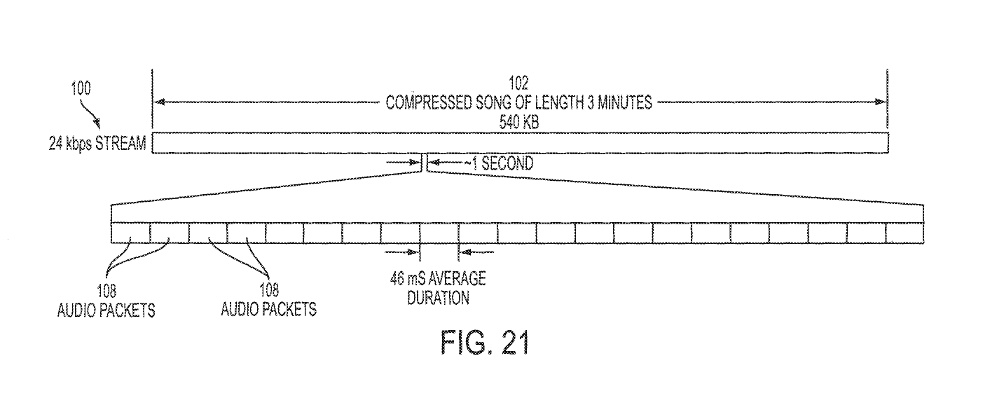

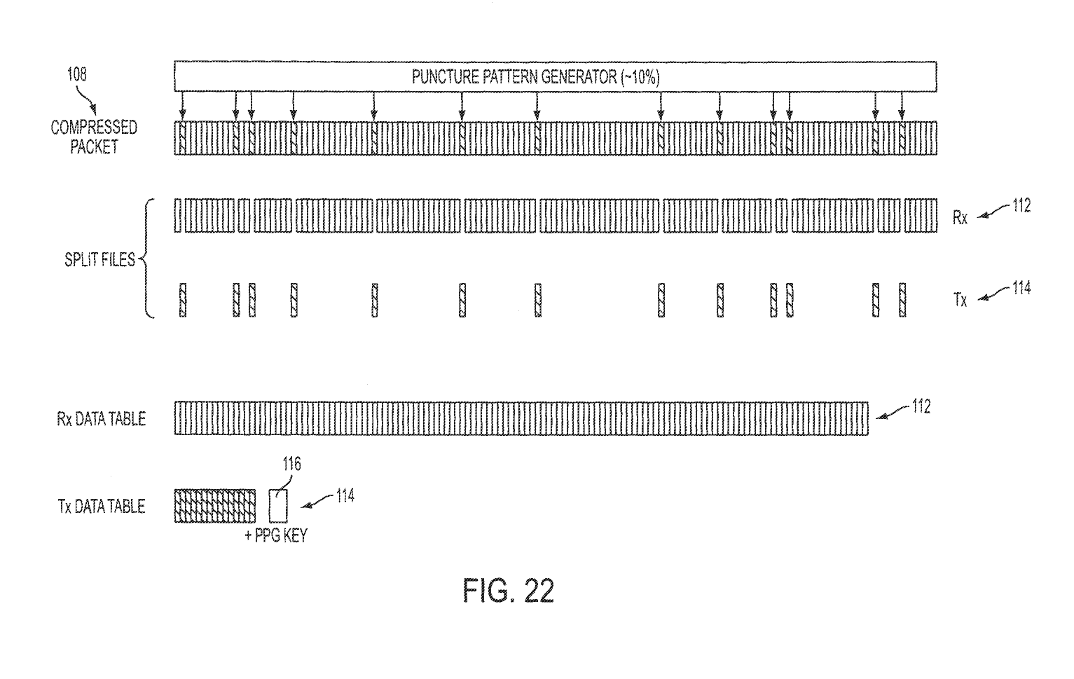

In accordance with another illustrative embodiment of the present invention and as described below in connection with FIGS. 21 and 22, program content to be transmitted to a receiver(s) can be subjected to a cryptographically generated puncture pattern to split out a controlled number of bytes from a stream of content (e.g., an audio stream) to create a locally stored (on the receiver) file (e.g., RX Data Table 112) and a transmitted file (e.g., Tx Data Table 114). The puncturing or splitting rate can be changed for a small fraction of the content file at both the beginning and the end of each file so that transmitted EBT files can slightly overlap each other and produce a crossfade effect more characteristic of live radio than streaming audio.

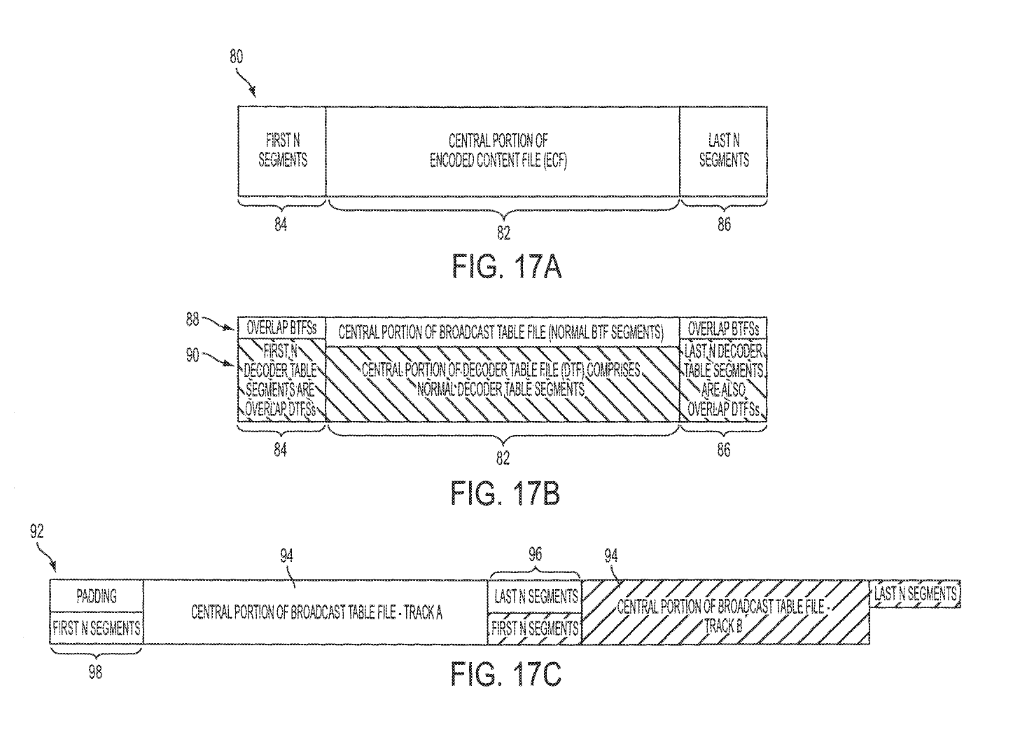

In accordance with an illustrative embodiment of the present invention, segments of different lengths can be used, which allows for greater control of instantaneous bandwidth when transmitting EBT files (e.g., BTFs) and, optionally, other content. Such control is useful for performing crossfades or inserting interstitial content between consecutive EBT files, for example, without increasing the instantaneous transmission rate. As shown in FIG. 17A, an encoded content file 80 can comprise segments. When the encoded content file 80 is split into corresponding EBT files such as, for example, a BTF 88 and a DTF 90, as shown in FIG. 17 B, the segments in a central portion 82 of the files 88 and 90 can have a selected size, while the sizes of a selected number N of the segments at the respective ends 84 and 86 of the files 88 and 90 can be smaller and larger, respectively. For example, the first and last N segments can be designated as overlap segments and, when the BTF 88 is created, these segments can be half the normal size of the BTF segments in the central portion 82 of the BTF to allow for overlapping transmission with another file, as shown in FIG. 17C, without an increase in instantaneous bandwidth. Correspondingly, the N segments in the portions 84 and 86 of the DTF 90 are generated as larger than the size of the DTF segments in the central portion 82 of the DTF to compensate for the reduced size of the BTF segments. Other ratios of the sizes of the N segments in an EBT file 88 or 90 relative to the size of the segments in the central portion 82 can, for example, be employed. The N segments in the DTF, nonetheless, can be sized such that they lack sufficient information to reproduce a decoded output that is recognizable with respect to the original content without combining with the corresponding BTF segment.

With reference to FIG. 17C, two transmitted EBT files are shown (e.g., corresponding to tracks or songs A and B) in a partial view of an exemplary transmitted EBT channel 92. In view of the variable sizes of the segments in a BTF, transmitted channel frames can, for example, contain a normal size segment for one track (e.g., a segment in a central portion 82 of the BTF for track A or B) as indicated at 94, or two “half-punctured” or otherwise reduced size segments from two different tracks as indicated at 96, or one half-punctured or otherwise reduced size segment plus padding or interstitial filler as indicated at 98. In any event, the transmitted channel frames containing the portions 84 and 86 of overlapping BTFs do not realize an increase in instantaneous transmission rate. For example, for a 2 kbps transmission channel, the overlapping half-punctured segments in the BTFs are only 1 kbps, respectively. Thus, their simultaneous transmission as indicated at 96, or transmission of one half-punctured segment and some interstitial content respectively at 1 kbps, as indicated at 98, does not increase the instantaneous transmission rate to 2-4 kbps as would be the case when variable size segments are not employed.

In accordance with another illustrative embodiment of the present invention, more information-dense or significant portions (e.g. more significant bits) of an encoded content file can be selected for placement into a selected one of the EBT files such as the transmitted EBT file (e.g., BTF in FIG. 1), which is generally the smaller of the two EBT files.

In some exemplary embodiments, the broadcast stream or other transmission mode (e.g., BTF in FIG. 1) for the content file can, for example, constitute 10 percent of the file content, while the remaining 90 percent of the file content (e.g., DTF in FIG. 1) can be represented at the receivers, to significantly increase the efficiency of the transmission mode. Other splitting ratios for the two EBT files can, for example, be used, including ones resulting in greater ratios than 90:10. It is also possible that the content file can be split into more than two parts with one or more selected parts being transmitted and one or more parts being stored at the receiver(s) for combination to generate a decoded content file, subject to the constraint, if desired or operative in various contexts, that the one or more stored parts do not together constitute enough information to make the resulting file recognizable as the original audio content without further combination using the transmitted file data.

FIGS. 15 and 16 illustrate splitting a digitally encoded audio file into two EBT files, that is, one having a majority of the digital content but denatured from the original content, and the other having missing content which can enable the reconstruction of a playable audio file. It is to be understood that the content delivery approach can also be used to split a digitally encoded video file into two files, one has a majority of the digital content but denatured from a video file, and the other has the missing content which can enable the construction of a playable video file, in accordance with an illustrative embodiment of the present invention. Similarly, an entropy-coded data file can be split into two files, preferably where one has a majority of the content that is denatured, and the other has the missing content which can enable the construction of a useful data file.

### Exemplary EBT Encoder Puncturing Using USAC

The Universal Speech and Audio Codec (USAC) is an example of an entropy-encoded audio compression standard. Entropy encoding maximizes compression by reducing redundancy in the compressed data file. As a result, almost all bits in the compressed data file are of significant importance to the decoding process. Puncturing even a small percentage of the bits in the data file can remove enough information such that the remaining data is not usable for generating even a rough approximation of the original content. Entropy encoding also maximizes the randomness and minimizes correlation between bits. This makes it almost impossible to intelligently guess the position and value of the punctured content. The following example demonstrates how reconstruction of the original information from the punctured data file alone is not a solvable problem. When an audio segment is encoded with the USAC audio encoder at a rate of 24 kbps, each 46 mS segment of the input audio stream is encoded to yield a variable length compressed output data packet averaging 138 bytes in length. Each output data packet has a total of 10 bytes punctured. Since each packet contains a 2 byte CRC, 2 of the 10 bytes are used to remove the CRC. The remaining 8 bytes (64 bits) are removed using a 1-bit resolution cryptographic puncture pattern from a 100 byte section (800 bits) of the packet which does not include certain fields, such as those containing common header bits, Spectral Band Reproduction (SPR) bits and/or parametric stereo bits. The remaining 736 bits (800-64) of the 100 byte section are stored along with the remaining non-punctured data packet bits in the receiver. In the absence of the transmitted data file, reassembling the original packet from the punctured packet presents a problem of the number of possible combinations 64 bits that can be added to the 736 bits. The number of possible puncturing position combinations is 800!/(64!*(800−64)!)=˜10⁹⁵. The possible values of the 64 bits, is 2⁶⁴ or ˜10²⁰ which results in an aggregate number of possible combinations of puncture patterns and values of ˜10¹¹⁵. Assuming that of these possible combinations, approximately one in a million will form a valid audio packet, then the possible number of valid audio packets which can be formed by the punctured packet is ˜10¹⁰⁹. Without the transmit file, each of the ˜10¹⁰⁹ packets is a possible solution, although only one is correct. If an average song is 3.5 minutes in length, it will contain approximately 4565 packets, where based on the punctured file, each packet in the song could have ˜10¹⁰⁹ possible options. The transmission file containing the punctured information is required in order to reconstruct the packet. Even though the punctured file stored at the receiver is not usable without the transmit file, typically the punctured file will be encrypted consistent with normal security practices. The puncturing method employed in this illustrative implementation can be scaled commensurately for use with other types of content (e.g., video) and encoding techniques or standards.

### Exemplary EBT Encoder Puncturing Using AAC

In its simplest form, the EBT encoder could puncture a block of N bits every M bits to achieve a puncture rate of N/M. However puncturing in this deterministic and non-targeted way, would not maximize the denaturing of the compressed audio packets. Thus, in many exemplary embodiments it is better to puncture the critical portions of the packets, in a non-deterministic pseudo random pattern, and in way that disrupts the decompression process the most. The following is an example of how this can be achieved with High Efficiency AAC v2 encoded content.

For HE-AACv2, each packet consists of a Mono Main Channel (0-5 KHz band), a Spectral Band Replication (5-15 kHz band), and Parametric Stereo (Left-Right Channel) subpackets. The Spectral Band Replication reproduces the higher frequency content by transposing harmonics from the Mono Main Channel and is therefore dependent of the Mono Main Channel. The Parametric Stereo is also dependent on the Mono Main Channel. Therefore, targeting mainly the Mono Main Channel for puncturing will not only degrade it, but also the Spectral Band Replication and Parametric Stereo.

The Mono Main Channel information is primarily compressed using an entropy encoder. Entropy decoding is a recursive algorithm based on making decisions along a binary tree. At each branching point, the entropy decoder determines whether the next bit is “1” or “0” based on the previous decision statistics (i.e., where it has been), and the remaining compressed bits (directions forward). A single puncture of the compressed bits will result in a wrong decision being made (e.g., a “0” is decoded instead of a “1”), which in turn changes the decision statistics, and causes additional wrong decisions later on. In addition, having more separate sparsely placed, amplifies the number of wrong decisions. Therefore, in exemplary embodiments of the present invention it is best to have many small punctured portions as opposed to a single large punctured portion in the entropy encoded content. In this example, instead of puncturing a single block of N bits, N single noncontiguous bits may be punctured in the Mono Main Channel entropy encoded content.

As a last step, the locations of the puncture bits may, for example, be distributed in a pseudo-random pattern. In this way, any attempt to reconstruct the original content is obfuscated both by the value and position of the punctured content. In this example, assuming that 1 in 10 bits are punctured, and a simple Pseudo Number generator is used to generate an integer (Ri) 0 and 9, the puncture position of the i th bit (Pi) would be Pi=10*i+Ri. In the depuncturing operation, the seed for the PN generator can be sent over the air along with the punctured content to facilitate decoding.

As stated above, one of the EBT files is transmitted whereas another corresponding EBT file is present and stored at a receiver(s). The transmitted EBT file (e.g., a BTF as described in FIGS. 1, 2 and 4) is typically the smaller of the two files and transmitted in real-time or near real-time (e.g., streaming or broadcast or on-demand). The stored EBT file (e.g., a DTF as described in FIGS. 1, 2 and 5) is typically the larger of the two files and stored ahead of time (e.g., non-real-time) in a receiving device, either at the time of manufacture, via a cached data transmission technique (e.g., data push), via a portable memory device, via downloading or other data pull technique, or via transmission during non-peak times or at lower rates, or other transfer or delivery techniques. It is to be understood, however, that the transmitted EBT file need not be smaller than the stored EBT file, but rather can be larger than the stored EBT file or substantially equal in size. In any event, bandwidth efficiency can be increased by splitting a content file and sending at least part of the file data to a receiver for storage independently of the transmission of the rest of the file data for later decoding. Further, the method or rate, ratio or degree to which a content file is split (e.g., puncturing rate, polynomial matrix used, size ratio of DTF to BTF, etc.) can vary depending on the type of content, type of transmission link, the capabilities of the target receiving device (e.g., memory and decoding capabilities), the application or service employing EBT, the period of use of stored files, among other considerations. For example, content files intended for a broadcast channel of high fidelity audio content can be subjected to a different puncturing ratio and/or file splitting method than original content files with the same content used for a normal fidelity broadcast channel. As another example, content files may be subjected to a different splitting method, rate or ratio if they are intended for a lower bit rate stream transmitted to devices with commensurate advanced decoding capabilities versus a higher rate stream for devices with standard decoding capability. In addition, the splitting ratio, method or rate can vary depending on the frequency with which a stored file (DTF) is updated or retained at a receiving device until replaced, or upon the specific type of content, or specific attributes of the content in the original content file, which can be determined using a pre-parser, for example, prior to encoding and splitting.

### Illustrative Methods for Transmitting and Storing EBT Files

In accordance with additional aspects of illustrative embodiments of the present invention, multiple approaches are available to transmit at least one of the EBT files created from a content file. For example, the transmitted EBT file (e.g., BTF in FIG. 1) can be broadcast, multicast, or unicast to one or more receivers and can be broadcast, streamed or otherwise transmitted using any of a number of different content delivery systems such as a digital audio broadcast (DAB) system, a radio system such as an FM radio system or a high definition (HD) radio system, a two-way Internet Protocol (IP) system, a Direct-to-home satellite video system or cable television system, among others. The transmitted EBT file can be transmitted over one or more satellite transmission paths or via a terrestrial wireless network (e.g., microwave, cellular, and so on), or streamed over an internet, cellular or dedicated IP connection (e.g., 2-way IP), or otherwise transmitted wirelessly or via wireline communications (e.g., wired networks).

In accordance with additional illustrative embodiments of the present invention, the end of one transmitted EBT file (e.g., BTF in FIG. 1) can be transmitted at substantially the same time as the beginning of a second EBT file (e.g., for cross fading or inserting interstitial content) without increasing the transmission bandwidth, as exemplified above in connection with FIGS. 17A through 17C.

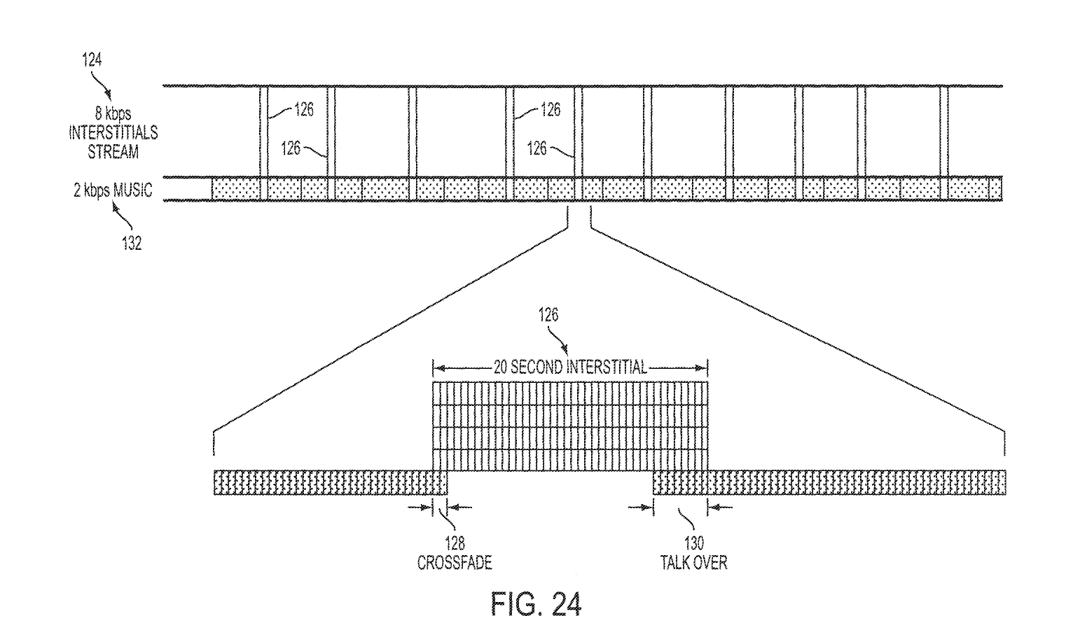

As an illustrative alternative to the example of using puncturing for crossfades (e.g. described below in connection with FIG. 24), crossfade instructions can be embedded into the transmitted EBT file, or the transmitted EBT file can be wrapped with playback instructions, so that the relative volume of a song or other content file with audio (i.e., the file that is fading out) and the subsequent song or content file with audio (i.e., the file that is fading in) can be adjusted by the receiver during the decoding and playback process.

As mentioned above in connection with EBT file libraries, an EBT channel can be created by transmitting a continuous sequence of EBT files (e.g., BTFs) corresponding to respective content files. In the above example, an EBT audio channel is generated using songs from a library. It is to be understood, however, that the sequence of EBT files need not be generated from content files that are the same content type, nor do the files need to correspond to a particular library of files at the receiver. In other words, the transmitted sequence of EBT files can comprise some form of metadata in the files themselves or within the channel to instruct a receiver on which stored EBT files (e.g., DTFs) are needed to decode the EBT channel.

Additional bandwidth efficiency, however, can be realized by employing libraries as exemplified above. For example, files transmitted on a particular EBT channel can be limited to files that are contained in a particular decoder table library or libraries. In accordance with another example, a customized sequence of EBT files (e.g., BTFs) can be transmitted that is tailored to the contents of a custom decoder table library, which is described further below, to create a custom EBT channel. In addition, library index and decoder file index information can be transmitted at substantially the same time as transmitted EBT file (e.g., the smaller of the two EBT files) and in the same transmission path.

As stated above, the stored EBT file (e.g., a DTF as described in FIGS. 1, 2 and 5) is typically the larger of the two files and stored ahead of time (e.g., non-real-time). It is to be understood that a stored EBT file (e.g., DTF in FIG. 1) can be transmitted using the same content delivery systems and transmission modes as the transmitted EBT file (e.g., BTF in FIG. 1).

The stored EBT file can be loaded into the receiver when it is manufactured or subsequently transmitted to the receiver (e.g., wirelessly transmitted or streamed via the internet), and can be periodically updated (e.g., over the air). The stored EBT file can also be provided to the receiver via downloading over the internet or transferred from another memory location (e.g., a portable memory device). In any event, the stored EBT file (e.g., DTF in FIG. 1) is generally available at the receiver prior to receipt of the transmitted EBT file (e.g., BTF in FIG. 1)

As stated above, receivers can be provided with EBT files (e.g., DTFs), as well as groups of EBT files (e.g., one or more libraries of files) for storage in read only memory (ROM) or other non-volatile memory associated with the receiving device (e.g., internal to the receiving device, or external to the receiving device and capable of being coupled thereto for file transfer and management operations). The stored EBT files and/or a library or libraries of stored EBT files can be provided on a removable digital storage medium (e.g., a flash memory device such as USB thumbdrive or micro SD, SDHC or SDXC card) from which the receiver is capable of retrieving EBT files and other data, code or instructions for accessing stored EBT files (e.g., for updating stored EBT files and/or libraries, or for combining with transmitted EBT files for decoding). In addition, a library or libraries of stored EBT files can be built into an application (i.e., an “App”) that can be downloaded into a multi-purpose internet-connected device for decoding and playing back content transmitted using EBT in accordance with illustrative embodiments of the present invention.

A radio receiver or other receiving device can be provided with a fixed set of libraries and, in addition, can optionally support expansion through the addition of more libraries (e.g., as exemplified in FIG. 11) in device memory or an associated memory. Libraries can also be replaced or updated (e.g., as exemplified in FIGS. 12 and 13). Further, a customized mix of stored EBT files (e.g., DTFs) can be selected to create a custom library that can be stored in flash or other non-volatile memory.

### Illustrative Methods for Combining and Playing EBT Files

As exemplified above in connection with FIGS. 1A-B, 2A-B and 6A-C, receivers combine locally stored EBT files with transmitted EBT files to decode and playback content transmitted using EBT in accordance with illustrative embodiments of the present invention. For example, locally stored EBT files (e.g., DTFs) can be combined with transmitted EBT files (e.g., BTFs) to produce a file which can then be decoded using a normal audio or video decoder or other type of decoder.

The file produced by the combining of EBT files can be temporarily buffered in random access memory (RAM) or volatile memory. As stated above, the EBT files (e.g., the stored and transmitted files) can, for example, be combined to recover the original digitally encoded file or at least a decoded and recognizable version of the original content file. As described herein, the transmitted EBT file (e.g., BTF) is generally not (but may be) stored at the receiver, for example, an EBT-enabled channel is played by decoding the file(s) in real-time. A receiver, however, can, for example, temporarily store the decoded file, such as buffering the EBT channel (e.g., stored in volatile memory) for various receiver operations such as, but not limited to, instant replay operations (e.g., rewind, fast forward, skip and pause/resume operations during real-time or near real-time playback), content preview operations (e.g., buffering EBT channels for scanning), channel surfing operations (e.g., ensuring certain types of content tracks are played from their starting points following channel changes), personalized channel operations (e.g., buffering selected EBT channels to automatically create personalized playlists), among other receiver operations. The decoded file can also be stored for longer periods of time such as, for example, for recording an EBT channel (e.g., recording an EBT channel for a limited period of time for deferred playback, or storing a data file decoded from EBT files). Illustrative operations using buffered channels are disclosed in Patent Application Publication Nos. 20080163290, 20090320075 and 20100268361, the entire contents of which are incorporated herein by reference.

Combined files can be played back at a receiver in real-time. In addition, buffered combined files from a single channel can be played in the same order that their corresponding EBT files were transmitted. As stated above, buffering combined files allows for files obtained from a single EBT channel to be played back in a user-controlled sequence using pause, rewind, and fast forward functions of the receiver or associated user playback device.

In accordance with an illustrative embodiment of the present invention, the transmitted EBT files from multiple broadcast EBT channels can be buffered in volatile memory at a receiver for playback in near real-time. For example, multiple, simultaneously transmitted EBT channels can be selected for buffering at the receiver to give the user the opportunity to switch between the buffered channels to hear preferred content from among them. The multiple buffered EBT channels can be a subset of EBT program channels that use the same library for channel content programming (e.g., channels carrying the same genre of music that use content from the same library of music to create their respective playlists). The library employed by the multiple buffered EBT channels is provided to receiver(s). A semi-customized playback channel can then be generated at a receiver by playing back buffered EBT files in a sequence from the multiple buffered EBT channels in a channel agnostic manner. For example, a user can skip a track on a currently tuned buffered EBT channel by changing to the buffered track of another buffered EBT channel. Even though a library may contain a similar genre of content, the variation of tracks stored in the library can be significant, adding to the content diversity among different channels (e.g., even among channels playing the same genre of music). This example of multiple buffered EBT channels permits a user to choose preferred content from among different simultaneously transmitted EBT files. Alternatively, a receiver can be programmed with existing technology to compare parameters and characteristics of content consumed by the user with the parameters and characteristics of buffered decoded files, as well as durations of time content shall remain in a buffer and any optionally stored user profile, to automatically select buffered content for playback based on the user's preferences. Coupled with the bandwidth saving benefits of using EBT files, this approach also provides programming sources with the opportunity to create additional programming channels to mine the contents of a library more comprehensively and effectively.

Thus, this use of buffered EBT channels produces essentially a semi-custom playback channel but without using a custom library or custom streamed content as will be described below, or any stored content. That is, this approach can be implemented in a one-way transmission system such as a digital audio broadcast system, in contrast to a two-way Internet Protocol connection to a programming source that can receive user feedback from the user receiving device or otherwise monitor user behaviors with regard to streamed content (e.g., types of streamed content requested and rejected, search queries and preferences, frequency and number of times of use, pauses, rewinds, skips, deletions, and the like). Only tracks or files in the currently playing buffer are available for inclusion in this semi-custom EBT channel, and the buffered content is erased when the radio is turned off. In an alternative embodiment, the combined EBT files (i.e., the files resulting from combining DTFs and corresponding BTFs) can be acquired for authorized storage and use. The stored, combined files can then be played back to a user in a random or pseudo-random order. Thus, if a receiver stores a certain library of content, the user can receive the BTFs for preferred content files for EBT decoding and pay to play preferred content from the library at their will. Again, this example implementation of EBT can produce a semi-custom channel using only a one-way transmission channel and therefore without using either a custom stream or a custom decoder table library as described below.

### Illustrative Applications of Enhanced Broadcast Technology (EBT)

Overview of Illustrative System Architecture

Illustrative embodiments of the present invention are described herein with respect to a satellite digital audio radio service (SDARS) that is transmitted to receivers by one or more satellites and/or terrestrial repeaters. It is to be understood that the advantages of the improved efficiency content delivery method and system of the present invention can be achieved in other broadcast delivery systems (e.g., other digital audio broadcast (DAB) systems or high definition (HD) radio systems), as well as other wireless or wired methods for content transmission (e.g., streaming music or video content over wireless or wired networks). Further, it is to be understood that the advantages of the present invention can be achieved by user devices other than radio receivers, including but not limited to smart phones, tablets, personal computers, and personal navigation devices.

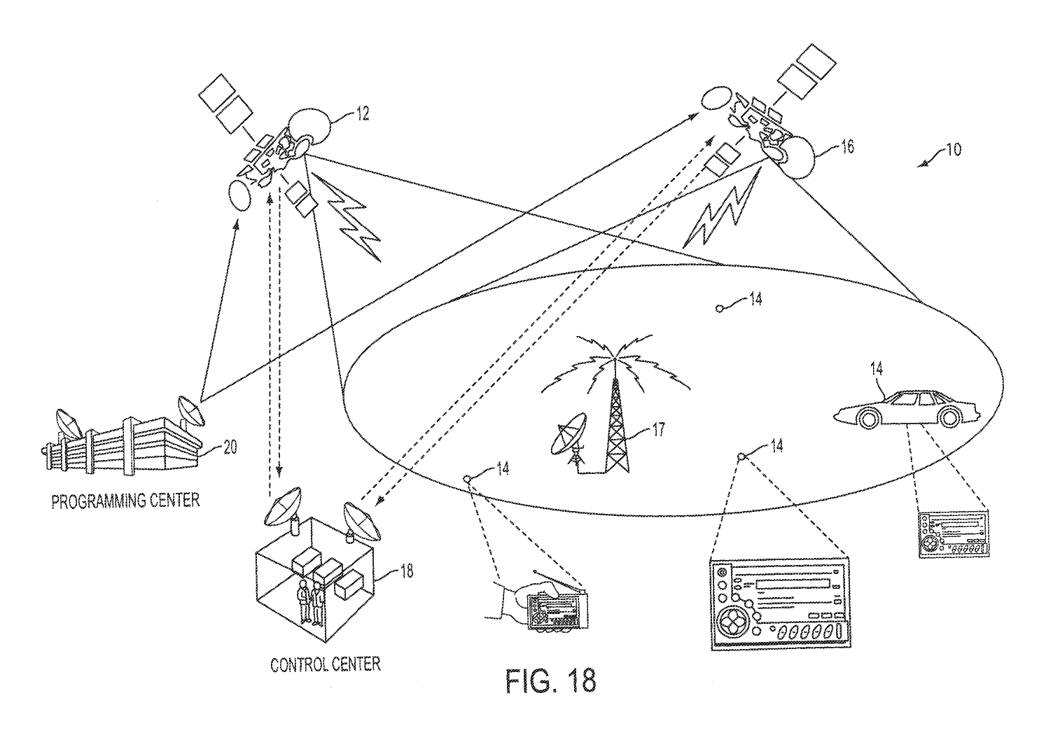

FIG. 18 depicts a satellite broadcast system 10 which comprises at least one geostationary satellite 12, for example, for line of sight (LOS) satellite signal reception at receiver indicated generally at 14. The satellite broadcast system 10 can be used for transmitting at least one source stream (e.g., that provides SDARS) to receivers 14. Another geostationary satellite 16 at a different orbital position is provided for diversity purposes. One or more terrestrial repeaters 17 can be provided to repeat satellite signals from one of the satellites in geographic areas where LOS reception is obscured by tall buildings, hills and other obstructions. It is to be understood that different numbers of satellites can be used, and that satellites in other types of orbits can be used.

As illustrated in FIG. 18, a receiver 14 can be configured for stationary use (e.g., on a subscriber's premises), or mobile use (e.g., portable use or mobile use in a vehicle), or both. A control center 18 is provided for telemetry, tracking and control of the satellites 12 and 16. A programming center 20 is provided to generate and transmit a composite data stream via the satellites 12 and 16 which comprises a plurality of payload channels and auxiliary information.

With reference to FIG. 18, the programming center 20 is configured to obtain content from different information sources and providers and to provide the content to corresponding encoders. The content can comprise both analog and digital information such as audio, video, data, program label information, auxiliary information, and so on. For example, the programming center 20 can provide SDARS having on the order of 100 different audio program channels to transmit different types of music programs (e.g., jazz, classical, rock, religious, country, and so on) and news programs (e.g., regional, national, political, financial, sports). The SDARS can also provide emergency information, travel advisory information, educational programs, and the like.

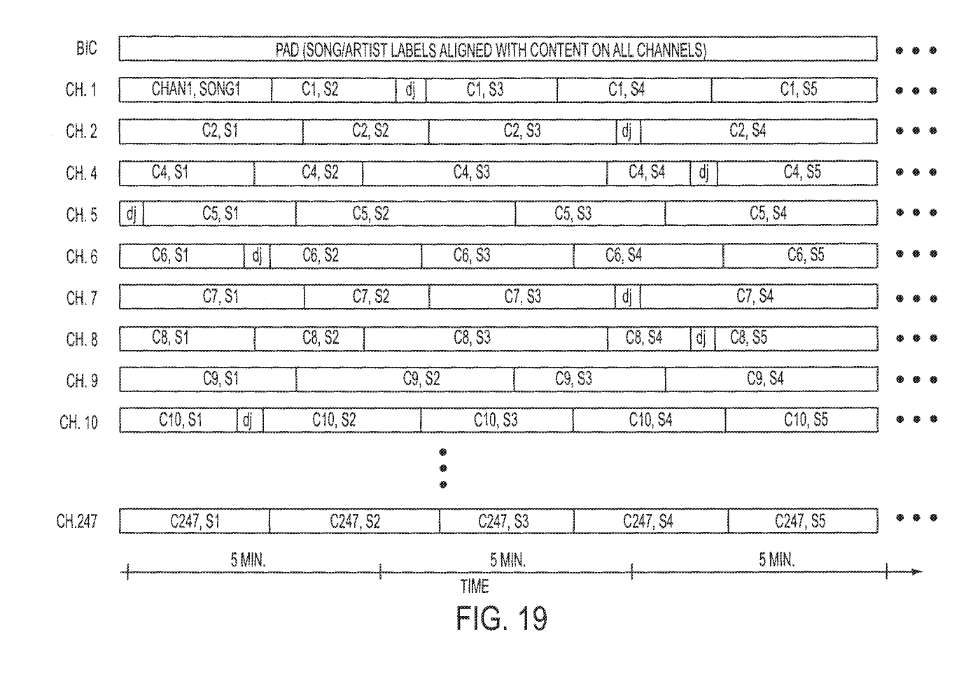

FIG. 19 illustrates different service transmission channels (e.g., Ch. 1 through Ch. 247) providing the payload content and a Broadcast Information Channel (BIC) providing the auxiliary information. These channels are multiplexed and transmitted in a composite data stream that can be a source stream for the receivers 14. The illustrated payload channels comprise audio content files such as songs indicated, for example, as S1, S2, S3 and so on) and disc jockey (DJ) talk audio content files indicated as “dj” in FIG. 19. The BIC can comprise, for example, messages that correspond to different payload channels. For example, a message can comprise Program Associated Data (PAD), as well as different formats and functions. Further, the timing of messages in relation to a particular channel can vary according to the needs of the service provider and to bandwidth requirements. In other words, a message need not be provided for all of the respective channels in every transmitted frame of the content stream.

In addition, it is to be understood that there could be many more channels (e.g., hundreds of channels); that the channels can be broadcast, multicast, or unicast to the receiver 14; that the channels can be transmitted over satellite, a terrestrial wireless system (FM, HD Radio, etc.), over a cable TV carrier, streamed over an internet, cellular or dedicated IP connection; and that the content of the channels could include any assortment of music, news, talk radio, traffic/weather reports, comedy shows, live sports events, commercial announcements and advertisements, etc. “Broadcast channel” herein is understood to refer to any of the methods described above or similar methods used to convey content for a channel to a receiving product.

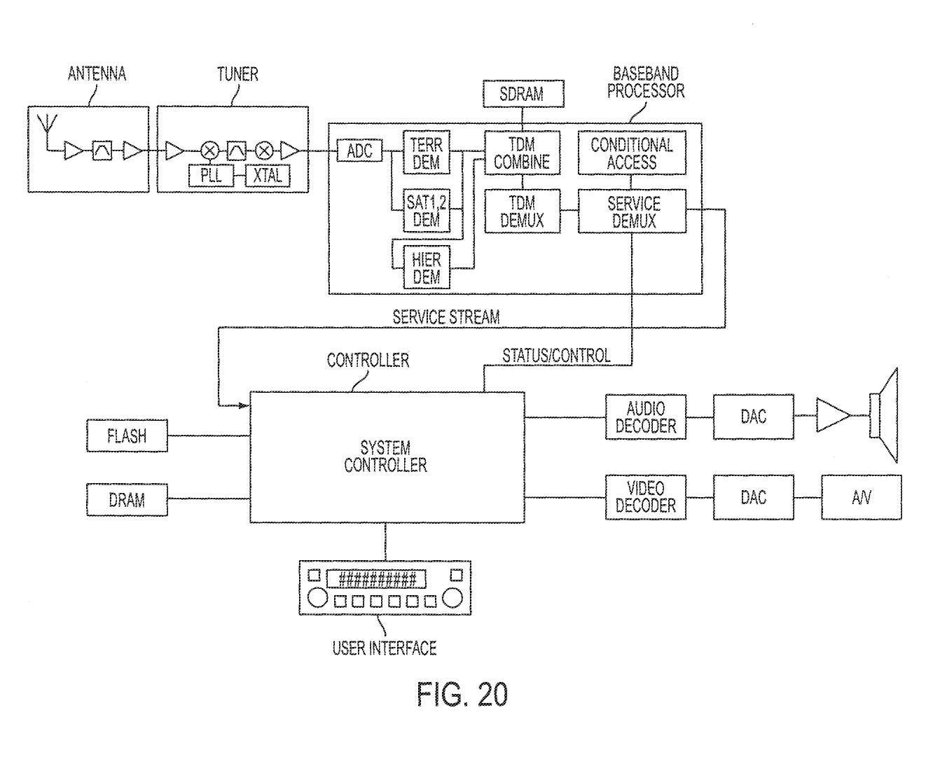

An exemplary receiver (e.g., for SDARS) will be now described with reference to FIG. 20. It is to be understood, however, that receivers configured for other content delivery systems and transmission modes can be used.

As shown in FIG. 20, the receiver 14 comprises an antenna, tuner and receiver arms for processing the SDARS broadcast stream received from at least one of the satellites 12 and 16, a terrestrial repeater 17, and optionally a hierarchical modulated stream, as indicated by the demodulators. These received streams are demodulated, combined and decoded via the signal combiner in combination with the SDRAM, and demultiplexed to recover channels from the SDARS broadcast stream, as indicated by the signal combining module and service demultiplexer module. Processing of a received SDARS broadcast stream is described in further detail in commonly owned U.S. Pat. Nos. 6,154,452 and 6,229,824, the entire contents of which are hereby incorporated herein by reference. A conditional access module can optionally be provided to restrict access to certain demultiplexed channels. For example, each receiver 14 in an SDARS system can be provided with a unique identifier allowing for the capability of individually addressing each receiver 14 over-the-air to facilitate conditional access such as enabling or disabling services, or providing custom applications such as individual data services or group data services. The demultiplexed service data stream is provided to the system controller.

The system controller in the radio receiver 14 is connected to memory (e.g., Flash and DRAM), a user interface, and at least an audio decoder. Storage of the local file tables at the receiver 14, for example, can be in Flash, ROM, Hard Drive or other non-volatile memory. In one example, an 8 GB Flash device, which can store content tables for 24 kbps parametric stereo audio files of 4 minute duration each, can hold decoder file tables for over 10,000 songs or similar duration and quality audio content files.

With continued reference to FIG. 20, decoded audio signals are converted to analog signals and amplified for playback by a speaker. A video decoder can also be provided. Reference is made to commonly owned U.S. Pat. Nos. 7,809,326 and 8,223,975, the entire contents of which are hereby incorporated herein by reference, for illustrative storage of received broadcast or streamed content at a user device.

Content Delivery in a Digital Audio Broadcasting (DAB) System Using EBT

With reference to FIG. 15, an application of a content delivery method and system having increased bandwidth efficiency will now be described in accordance with an illustrative embodiment of the present invention. More specifically, SDARS or similar content service that provides music programming is enhanced by the ability to transmit additional music channels that can be dynamically added using Enhanced Broadcast Technology (EBT) in accordance with an illustrative embodiment of the present invention.

In this example, an “EBT Channel” refers to music channels broadcast using Enhanced Broadcast Technology (EBT), which increases the broadcast efficiency in the range of 2.8× to 10×, depending on the broadcast configuration. EBT Channels can contain interstitials (e.g., channel introductions, DJ banter, and the like) which are added by the programming staff in a manner similar to normal channels (e.g., the basic SDARS channels such as those described with reference to FIG. 19) using an EBT Channel production toolset. EBT Channels have the same sound quality as normal channels and use the same tuning interface at the receiver 14 as normal channels. EBT Channels, however, are available in hierarchical modulation-equipped receivers or other receivers that can also be equipped with EBT Channel control software and Flash memory. EBT can also be used to produce customized EBT channels that are transmitted via wired or wireless internet to individual radios. Since such channels are customized, production elements of a broadcast channel such as DJ interstitial banter could be omitted to produce an experience similar to online music streaming services. “Custom EBT channels” can be made available online, for example, and can use a different tuning interface. It would also be possible to preserve a broadcast channel tuning interface for online streaming service if a channel number or range of channel numbers is reserved for Custom EBT channels that would contain wholly or substantially unique content for each receiver based on the contents of the receiver's decoder table library or libraries. In one implementation channels above 999 could be used for custom channels. In another method, custom channels would be preceded with a prefix such as “C” to enable channel numbers such as C002, C045 that would be distinct from the broadcast channels 2 and 45 respectively, as well as from any C002 and C045 that might be present on a different receiver. In another method of identifying custom channels, a unique identifier such as the Radio ID of the receiver device or the subscriber's account number could be attached to the channel number. This implementation or something similar could be used at the broadcast facility to distinguish each of the custom subscriber channels.

Briefly, systems and methods for transmitting and receiving additional data, such as video data or additional dynamically added music channels, over legacy satellite digital audio radio signals can employ hierarchical modulation to transmit secondary information over a legacy signal. For example, a SDARS system 10 as illustrated in FIG. 18 can use a second layer of modulation to transmit additional content on top of its regular audio signal programming. In other words, to support future services within the original system design, hereinafter referred to as a “legacy” system, additional information bandwidth can be acquired by using hierarchical modulation, for example, to overlay data for such new services on top of the legacy transmission. In such a system, for example, overlay data can be transmitted by applying a programmable angular offset to legacy QPSK symbols, for forming a new constellation similar to 8PSK. FIG. 20 depicts a receiver 14 having a hierarchical demodulator and Flash and control software for processing hierarchical demodulated channels for enhanced broadcast technology or EBT. Legacy receivers 14 do not have the Flash or hierarchical demodulator or control software and therefore are not eligible to playback these additional music channels or future services.

In the illustrative embodiment, an EBT Channel is generated from a fixed music library of generally less than 500 songs and contains interstitial content totaling less than five minutes per hour. The EBT Channel increases the efficiency of broadcast bandwidth by splitting the music library content into two compressed table files or data tables. The first data table (i.e., the Tx Data Table 64 in FIG. 15) is stored at the broadcast site or content source (e.g., the programming center 20), and the second data table (e.g., the Rx Data Table 62 in FIG. 15) is stored locally in the receiver.

The Tx and Rx Data Tables 62 and 64 can be generated in advance for each individual encoded content file broadcast with EBT. For example, with reference to FIG. 15, when a song of three minutes duration is fed into the audio encoder 60 for compression to 24 kbps parametric stereo, the output will be a 24 kbps stream indicated at 100 in FIG. 21 of three minutes duration.

As shown in FIG. 21, the three minute audio stream 100 size is 540 KB and is comprised of a series of variable length audio packets 108 with an average length of 46 mS or 138 Bytes. Although variable in length, each compressed packet 108 is formed from a fixed 46 mS interval of uncompressed audio. The Rx Data Table is generated by puncturing the 540 KB stream at the byte level with a cryptographically generated puncture pattern, for example. The 540 KB stream could optionally be punctured with any pattern ranging from a spread of single bits to one or more groups of bits. This process is shown for a typical audio packet in FIG. 22.

In accordance with an illustrative embodiment of the present invention and with reference to FIG. 22, each audio packet 108 in the compressed song is subjected to the puncture pattern which splits out a controlled number of bytes to form a Rx Data Table 112 and a separate Tx Data Table 114. The Puncture Pattern can be aligned with the 432 mS satellite transport frame and is seeded with a randomly generated key 116 in the range of 80 bits, for example. This key 116 is stored for every 432 mS transport frame and transmitted along with the Tx Data Table 114 to facilitate reassembling the Rx Data Table 112 and Tx Data Table 114 in the receiver 14 on a frame by frame basis.

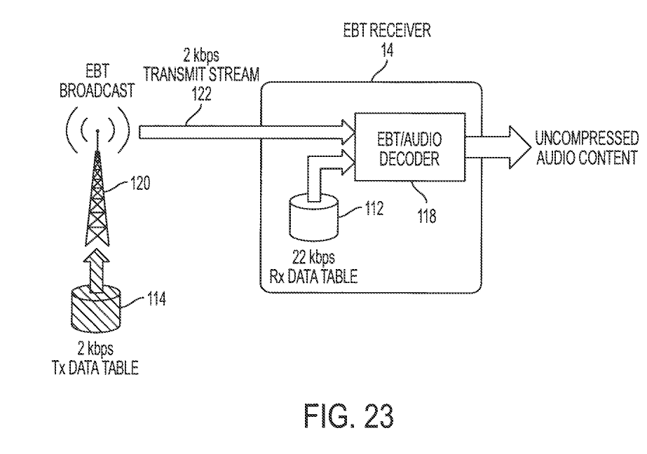

Under this example, the Rx Data Table 112 stored in the receiver 14 is comprised of incomplete compressed audio data packets which cannot be used to recreate all or even a portion of the uncompressed audio since the critical data needed for playback (e.g., both the missing data and the locations where the data is missing) is contained in the separate Tx Data Table 114 located at the broadcast site. When the Tx Data Table 114 is broadcast, streamed or otherwise transmitted as indicated at 120 in FIG. 23, the receiver 14 performs EBT decoding as indicated at 118 by combining the received Tx Data Table 112 with the locally stored Rx Data Table 114 to form complete audio packets 108, or at least substantially complete audio packets, which are applied to the audio decoder also indicated at 118 to output music (e.g., music that meets at least minimum quality criteria).

The 2 kbps transmit stream 122 in FIG. 23 contains the Tx Data Table content, as well as the keys and control information that instructs the receiver 14 which data to retrieve from local Rx Data Table storage and how to combine it with the transmitted data table to recreate the original audio packets. Reconstruction of the audio packets can occur in real-time with the broadcast such that no delays are incurred when tuning to the channel.

In the event the 2 kbps transmit stream 122 is interrupted as a result of channel impairments, the receiver 14 is unable to reconstruct audio packets for the duration of the interruption. Standard error concealment techniques are applied to the audio output stream during interruptions of the 2 kbps transmit stream 122 which is equivalent to the error concealment used when a 24 kbps channel containing complete audio packets is interrupted. The local Rx Data Table 114 does not provide a benefit to the receiver 14 when errors are present on the transmission channel.

With reference to FIG. 24, interstitials 126 are broadcast in real-time with a separate 8 kbps or higher bit rate compressed stream indicated at 124 and can overlay the music stream 132 to enable crossfades 128 and DJ talkover 130 similar to standard music channels. Total interstitial content is preferably minimized to below 5 minutes per hour to maintain maximum bandwidth efficiency. For reference, three minutes of interstitials per hour is roughly the equivalent to the DJ talking for 20 seconds between every two songs.

The receiver 14 combines the reconstructed music broadcast stream 132 and the 8 kbps interstitial stream 124 in real-time to generate the EBT Channel audio. An example of the instantaneous broadcast bandwidth requirements for one EBT channel over the period of approximately one hour is shown in FIG. 24.

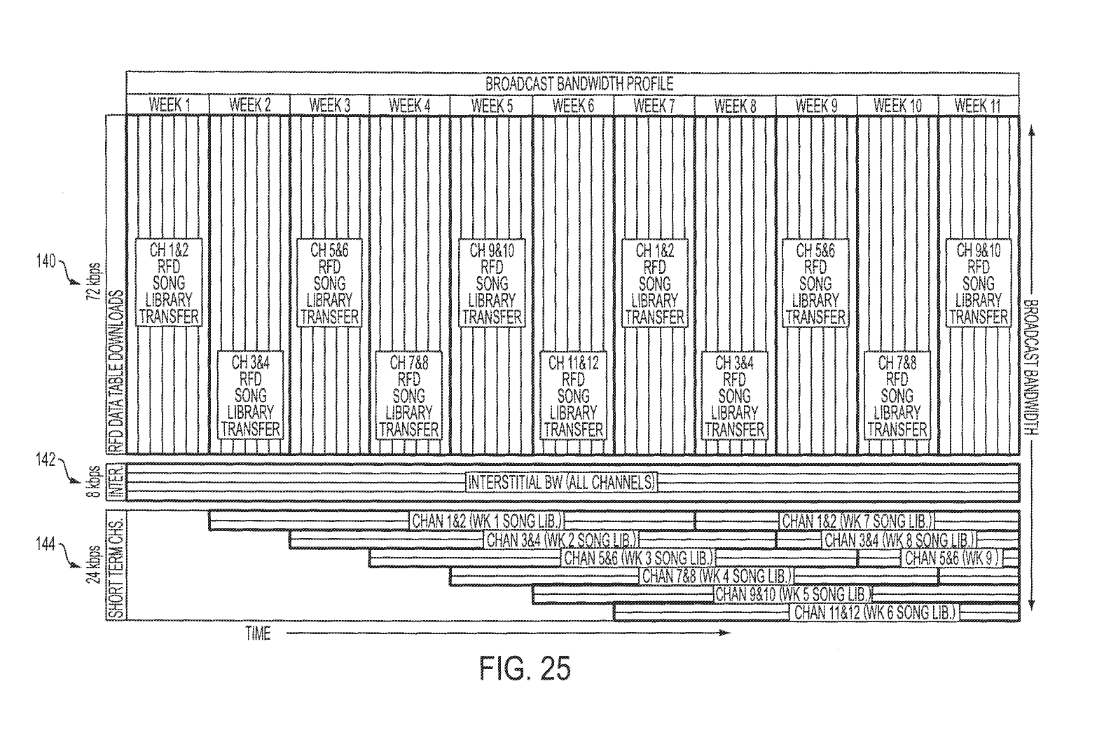

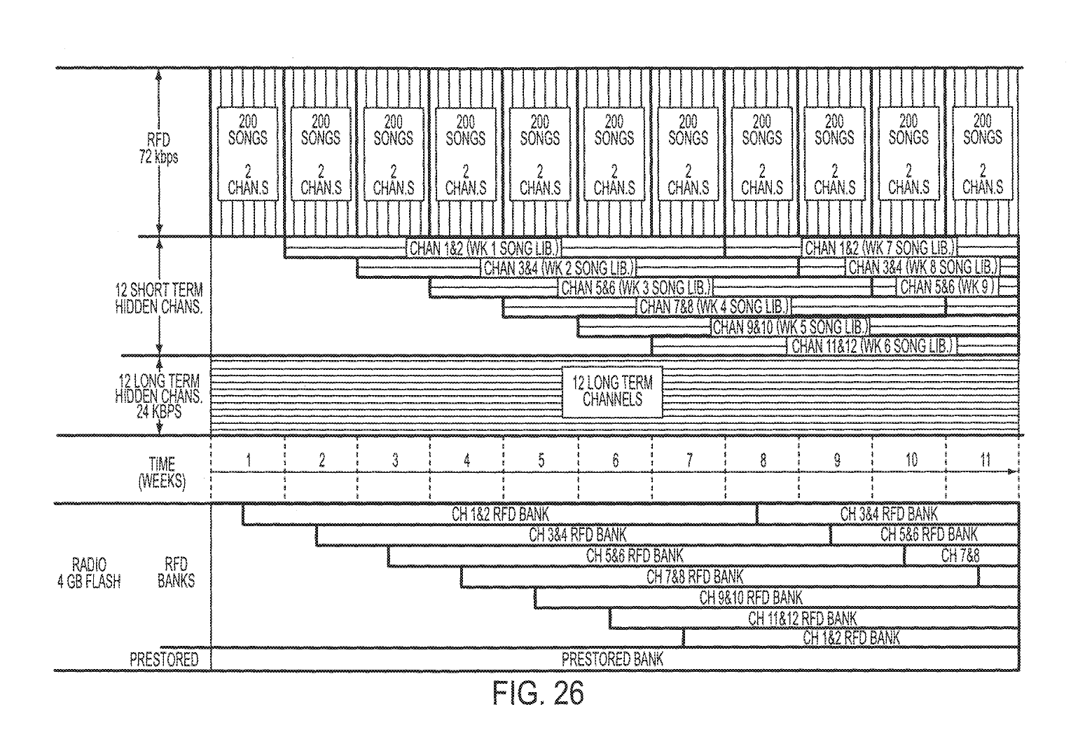

With continued reference to FIG. 24, note that the instantaneous bitrate will vary between 2 kbps and 10 kbps as a function of the interstitial transmissions. As will be described below in connection with FIGS. 25 and 26, advantageous techniques are deployed on the broadcast or transmission side in accordance with an embodiment of the present invention to manage these short duration peaks in bandwidth. For an EBT Channel with three minutes of interstitials 126 per hour, the average broadcast bitrate is 2+8(3/60)=2.4 kbps. For comparison, the equivalent bandwidth required for a standard music channel using parametric stereo is 24 kbps.

Interstitial Content Insertion with EBT Files

As noted above in connection with FIGS. 17C and 24, digitally encoded audio files comprising interstitial material can be transmitted that has not been EBT encoded or split substantially simultaneously or preferentially slightly in advance of a gap in the transmission of a sequence of transmitted EBT files (e.g., BTFs). An indication can be provided in the streaming channel that a particular interstitial file should be played, and what the index of that interstitial file should be. In addition, interstitial material can be automatically buffered and stored at receiver(s) for later insertion into an EBT channel along with an index that uniquely identifies that interstitial content. Thus, in accordance with an illustrative embodiment of the present invention, a receiver can seamlessly switch from combining EBT files (e.g., BTFs combined with corresponding stored DTFs during EBT streaming) to playing a non-EBT encoded file such as interstitial material when an indication is received, and then return to normal EBT playback when the interstitial file is completed or when the radio receives an indication in the live stream to do so regardless of whether the interstitial playback is complete or not.

EBT Content Delivery with Regional or Multi-Lingual Interstitial Content

The bandwidth savings realized by delivery content such as music or video programming using EBT files allows content providers and programming stations to expand their interstitial content reach more audiences with different demographics. For example, a multi-lingual channel can be produced in which music or video program content is delivered via EBT files, while the DJ interstitial material and other commentary on the music is delivered as interstitial content. Instead of delivering a single piece of interstitial material to fill a gap in the sequence of transmission of the transmitted EBT files (e.g., BTFs), a broadcast server can transmit two or more interstitial segments in respective languages for the same interstitial gap. A receiver, in turn, can play one of the two or more interstitial segments depending on a user-selectable language preference. This application is useful for a European radio broadcast system or other regional broadcast system in which multiple languages must be supported for variable content such as advertising and DJ commentary, while quasi-static content (e.g., music, video, data, images) is common to all languages.

Similarly, an EBT channel can be produced with regionalized commercial insertion. For example, quasi-static content such is delivered via EBT files to all users, while interstitial advertising is regionalized in some or all cases. The broadcast or transmission channel would transmit two or more interstitial segments of advertising with a tag or wrapper that is associated with a geographical region. The receiver, in turn, can play the segment that most closely matches the current location of the receiver, along with the content decoded from the EBT files. This permits segmentation of advertising space on broadcast voice-tracked EBT channels or similar types of programming channels to multiple regions.

### Long Duration and Short Duration EBT Channels

EBT Channels can be categorized as either long duration channels which can be broadcast for years, short duration channels which can broadcast for a few weeks, or Custom EBT channels which are continually being modified in response to user feedback. In order to play a short duration or long duration EBT Channel, the receiver 14 employs a complete Rx Data Table for that channel stored in local Flash memory. Both long duration and short duration EBT channels can be transmitted over satellite or other broadcast media or one-way transmission system, for example. On the other hand, in order to play Custom EBT channels, the receiver 14 employs a customized decoder table library or libraries, as described below. EBT-capable Receivers may support any one of these EBT channel types, any combination of these types (for example Long duration and Custom), or all three types of EBT channels.

Long duration EBT Channels can be programmed, for example, using music libraries which are not subject to change, with examples including the SDARS programmer-defined or Billboard-defined top 300 Country Hits of the 80s, the top 400 Country Hits of the 90s, the top 400 Dance/Club Songs of the 90s and the top 400 Rock Hits of the 60s and 70s. The Rx Data Tables 114 to support the reception of long duration channels can be loaded into the receiver 14 at the time of manufacture. These channels realize an approximate 10:1 bandwidth efficiency factor since broadcast bandwidth to download Rx Data Tables to the receiver is not required. If an EBT Channel service is comprised of only long duration channels, each channel is buffered at the transmitter 120 to enable time averaging of the interstitial bandwidth peaks. This introduces a delay in the ability of the receiver to play a live interstitial each time the receiver is powered up while the interstitial time averaging buffers are filled. If an interstitial is scheduled for play during this initial buffering period, a default interstitial stored in flash may be substituted. Once the buffers are full, live EBT interstitials can be immediately available.

The Rx Data Table Files to support the reception of short duration channels are generally not expected to be available at the time of manufacture and therefore are scheduled for delivery to the receiver 14 over-the-air. These tables can be broadcast to the receiver, for example, using the Reliable File Delivery (RFD) protocol (e.g., the data encoding technology described in commonly owned U.S. Patent Application Publication No. US 2010/0106514, the entire contents of which are incorporated by reference herein) prior to commencement of the live broadcast, for example. By way of an example, a short duration EBT Channel can be programmed using a 200 song music library and support a broadcast duration of 6 weeks or longer. The Rx Data Table for the 200 songs can be broadcast for one week using 72 kbps, and would require a cumulative “receiver on” time of 4 hours to complete the download. Receivers 14 that are not active during any given Data Table RFD broadcast period would not be able to receive the associated EBT Channel broadcast. Devices with IP connectivity can have these Rx Data Tables downloaded automatically when connected to the SDARS provider servers. Subscribers could also have the option to download the missing Rx Data Tables via USB or WiFi, or to provide the missing tables to the receiver with a removable Flash device. Alternatively, the Rx Data Table transmission duration can be extended beyond a week to assure that more of the target radio population receives the table.

Provided each 200 song library supports two simultaneous channels, a short duration EBT Channel service comprising 12 channels in a staggered 6 week rotation would require 72 kbps RFD bandwidth (BW), 24 kbps Channel BW and 8 kbps interstitial BW for a total of 104 kbps. The broadcast bandwidth profile is shown in FIG. 25.

FIG. 25 depicts the broadcast bandwidth usage versus time for the short duration EBT channel service. The 72 kbps indicated at 140 is a RFD transmission to update song library Rx Data Tables in the receiver Flash memory. The 8 kbps indicated at 142 is used to support interstitial transmissions, as discussed in more detail below. The 24 kbps indicated at 144 supports twelve independent channel broadcasts at 2 kbps each. Each week, a new library of 200 song Rx Data Tables is downloaded to all capable receivers 14 which have at least four hours of “on time” during the week. As noted above, alternatively the table transmission times can be extended to longer than a week to assure a higher percentage of receivers acquires the tables.

Each new receiver typically starts out with no short duration Rx Data Tables and therefore cannot initially tune into the short duration EBT Channels. After receiving the first song library Rx Data Table in Week 1, Channels 1 & 2, each programmed with the first song library, would become available with the channel broadcast beginning in Week 2. Continuing RFD song table downloads, after receiving the second song library tables in Week 2, Channels 3 & 4 would become available with the channel broadcast beginning in Week 3. This process can continue until 12 EBT channels are available at the beginning of Week 7. Thereafter, two new EBT Channels can be rotated into the group of 12 channels every week. Subscribers have the option to manually download any missing song library data tables at any time.

As a result of the additional RFD bandwidth required to continuously update the song libraries (Rx Data Tables) over the air, the average bandwidth per channel for this service is 104/12=8.67 kbps. With the broadcast configurations defined here, the bandwidth efficiency factor for the short duration EBT Channel is 24/8.67=2.8× (e.g., 2.8 times greater than a transmission of the channel content without use of data tables), while the bandwidth efficiency factor for the long duration EBT Channel is 24/2.4=10×.

An EBT Channel service that includes a mix of long duration channels and short duration channels provides mid-range bandwidth efficiency factor and enables a technical solution for management of the bandwidth peaks created when the 8 kbps interstitials are present on multiple channels simultaneously. A typical mixed service configuration for 24 channels is shown in FIG. 26.

With reference to FIG. 26, 4 GB of Flash in the receiver 14 is partitioned into one large bank containing pre-stored Rx data tables to support long duration channels and multiple smaller banks containing Rx data tables loaded via RFD to support short duration channels. Table 1 summarizes the key parameters of an example EBT service mixing long and short duration channels.

TABLE 1
EBT Channel Service Parameters for 24 Channel Mix

| Parameter | Value |
|---|---|
| Total Service Bandwidth | 128 kbps |
| Long Duration Channels | 12 |
| Short Duration Channels | 12 |
| Total Channels | 24 |
| RFD Bandwidth | 72 kbps |
| Interstitial Bandwidth | 8 kbps |
| Receiver Flash | 4 GB |
| Bandwidth Efficiency Factor (24 kbps reference) | 4.5 X |

With an even mix of long and short duration channels, the EBT Channels service achieves a bandwidth efficiency factor of 4.5×. With a 2:1 mix of long and short duration channels the efficiency factor could be improved to 5.7×.

The interstitial bandwidth allocation of 8 kbps in Table 1 assumes that each of the 24 channels will average 2.5 minutes of interstitials per hour and the interstitials are encoded at 8 kbps. For the 24 channels, the total interstitial time per hour is the 2.5 minutes/channel×24 channels=60 minutes. The total interstitial bandwidth averages out to 8×(60 min./1 hour)=8 kbps although the instantaneous bandwidth can vary considerably. The RFD bandwidth associated with the short duration channels is available to support the instantaneous bandwidth peaks which occur when multiple channels simultaneously play interstitials. For example, if interstitials were to line up on 7 channels at the same time, the instantaneous bandwidth requirement would be 7×8 kbps=56 kbps, which temporarily exceeds the allocated interstitial bandwidth of 8 kbps in Table 1. This bandwidth is required for each 432 mS frame wherein all 7 channels overlap. Since the RFD bandwidth can be adjusted on a frame by frame basis without a negative impact on the download, the 8 kbps interstitial bandwidth and 72 kbps RFD bandwidth are pooled to allow frame by frame peak allocations of up to 80 kbps for either RFD or interstitials as required. Independent of the peak frame bandwidth allocations, the average bandwidths for RFD and the interstitials are maintained 72 kbps and 8 kbps, respectively.

In order to characterize the probability for interstitials to simultaneously align on multiple channels over the course of 1 year, simulations were generated based on 12 and 24 channels with 2.5 and 5 minutes of interstitials per channel per hour. Results for 24 Channels and 2.5 minutes of interstitials are shown below.

Simulation #1: 24 Channels, Interstitials = 2.5 Min./Hr., 1 Year Statistics:

| Input Parameters: | |
|---|---|
| Ave. Song Length (sec) = | 210 |
| Min. Song Length (sec) = | 150 |
| Max. Song Length (sec) = | 270 |
| Ave. Interstitial Length (sec) = | 20 |
| Min. Interstitial Length (sec) = | 10 |
| Max. Interstitial Length (sec) = | 30 |
| Simulation Step Size (sec) = | 0.50 |
| Interstitial Bit Rate (Bits/Sec) = | 8000 |
| Ave. Interstitial Time Per Hour (min) = | 2.5 |
| Number of Channels = | 24 |
| Simulation Run Time (days) = | 365 |
| Random Number Generator Seed = | 321 |
| Derived Parameters: | |
| Ave. Songs Played Per Hour = | 16.43 |
| Ave. Interstitials Played Per Hour = | 7.50 |
| Interstitial Insertion After Each Song Probability = | 45.65% |
| Number of Simulation Run Sample Steps = | 63072000 |

Simulation Results:

| Interstitial | Samples |
|---|---|
| BW (Bits/Sec) | Equal |
| 0 | 22729121 |
| 8000 | 23691045 |
| 16000 | 11834136 |
| 24000 | 3781219 |
| 32000 | 863532 |
| 40000 | 149867 |
| 48000 | 20763 |
| 56000 | 2120 |
| 64000 | 169 |
| 72000 | 28 |
| 80000 | 0 |
| 88000 | 0 |
| 96000 | 0 |
| 104000 | 0 |
| 112000 | 0 |
| 120000 | 0 |
| 128000 | 0 |
| 136000 | 0 |
| 144000 | 0 |
| 152000 | 0 |
| 160000 | 0 |
| 168000 | 0 |
| 176000 | 0 |
| 192000 | 0 |

In summary, the simulations in this example show that with 24 channels and 2.5 minutes of interstitials per hour, the peak interstitial bandwidth requirement is 72 kbps and this will occur during 28 frames per year. Since 80 kbps of pooled bandwidth is available to support peak interstitial BW needs, the broadcast bandwidth profile supports a real-time EBT Channel Service without the need for time averaging buffers at the broadcast site 20 or at the receiver 14.

The scenarios described above illustrate a specific operational intent of providing a pair of new short duration channels every week, with each short duration channel “on air” for 6 weeks, and a total of 12 short duration channels on air at any given point in time. Other operational variants can be supported, with more or fewer short duration channels on air at a time; longer times to send the Rx Data Channels; longer or shorter on-air times for the channels; less regularity in the start time and duration for the channels; etc. All these variations can have some effect on the bandwidth required (more or less required), but are technically feasible.

Thus, an EBT Channel Service can be configured to provide long duration channels which use Flash song tables loaded at the factory, short duration channels which use Flash song tables loaded via RFD bandwidth, or a combination both long and short duration channels.

### Denatured DTF File Example

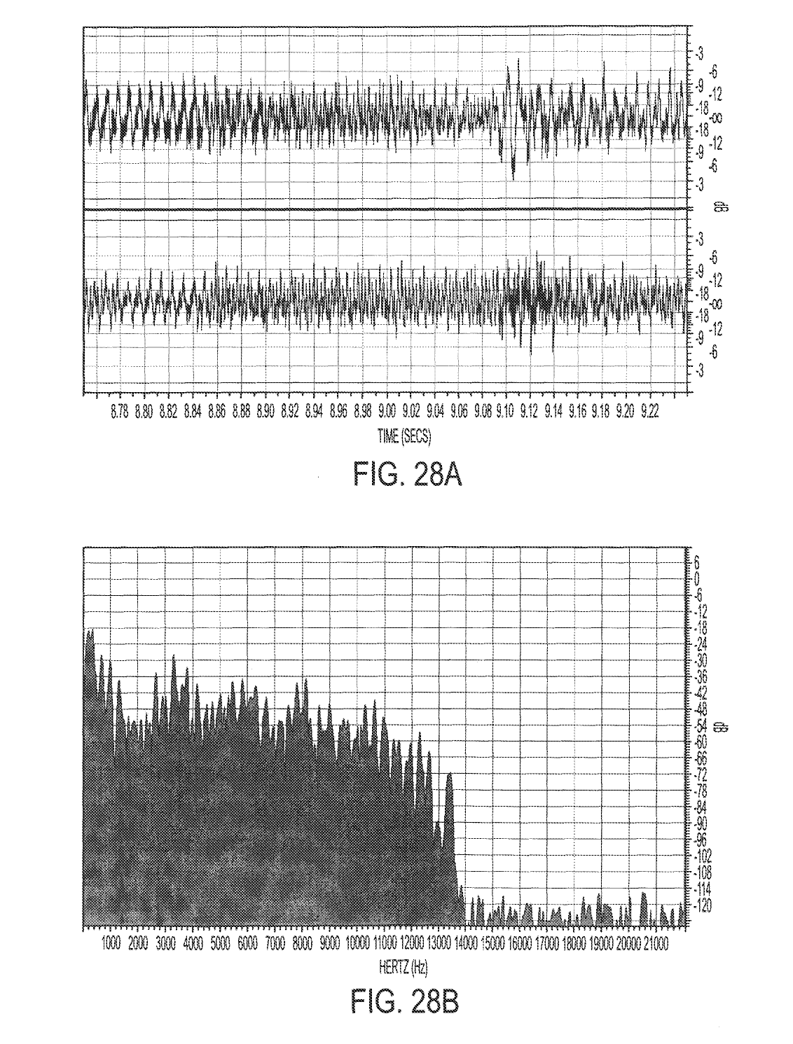

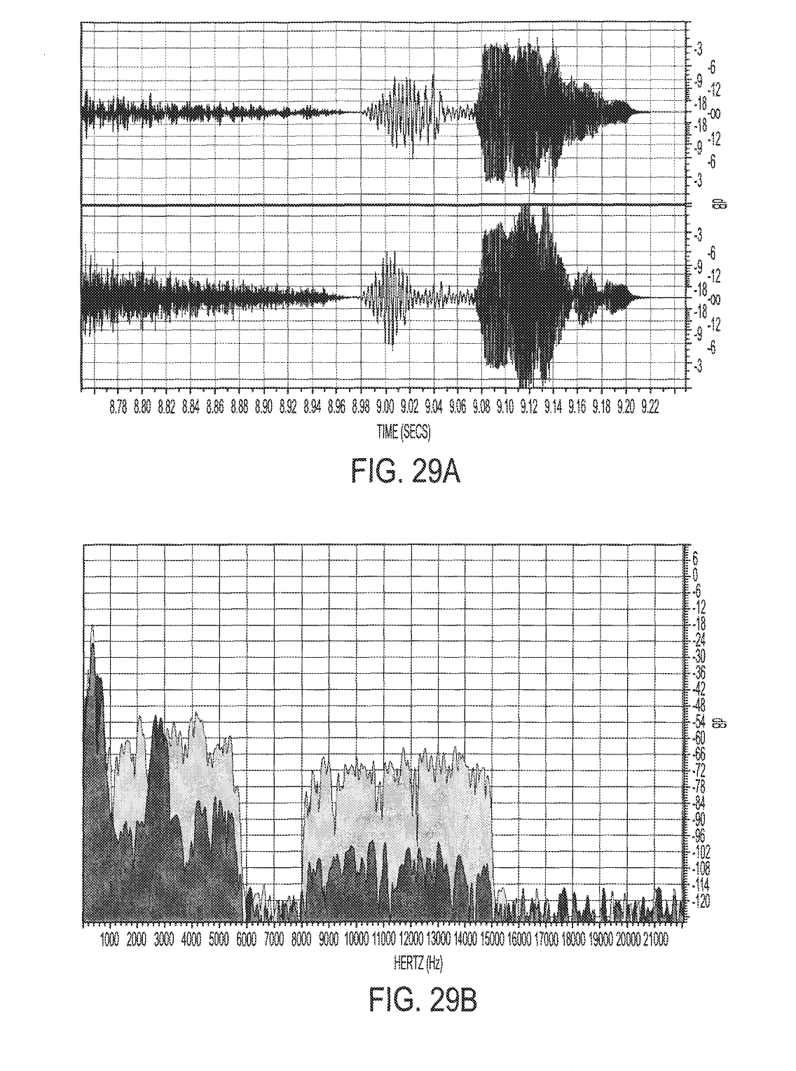

FIGS. 28A and 28B and FIGS. 29A and 29B illustrate the differences between what one hears when an original audio content file is played, and what one hears if a DTF derived from the content file using EBT is attempted to be decoded without its corresponding BTF and played on a user device or receiver. With reference to FIG. 28A, there is shown an amplitude versus time plot of the two stereo channels of a portion of a song which shall be considered an original audio content file for the purposes of this example. Similarly, FIG. 28B is a spectral component plot (e.g., amplitude versus frequency) of this song. FIG. 29A shows an amplitude versus time plot of the portion of the song after being processed using EBT (e.g., by puncturing as illustrated in FIG. 22) and therefore denatured. FIG. 29B is a frequency plot of that same denatured portion of the song. As is readily seen, the amplitude plot of the DTF is unrecognizable as being related to the amplitude plot of the original content file, and the frequency analysis plots show exactly why. Comparing FIGS. 28B and 29B, it is clearly seen that all of the component frequencies have changed in amplitude, and some very radically. Moreover, the DTF has strong amplitude at frequencies that were never part of the original file. If one plays the DTF file represented in FIG. 29, one hears cracks hisses, bass frequency moans and rumbles, but no music.

This result can also be understood in terms of FIG. 22. As is known, all digital files comprise sequences of 1s and 0s. What is important therefore to reproduce a song or other content file is not just the numbers of 1s and 0s, but their precise sequence within a frame. When a compressed packet is punctured as shown in FIG. 22 to create the two split files Rx and Tx, the remaining bits are concatenated together to create Rx DATA TABLE 112, thereby obscuring any information that may have been gained from the data in the respective bit positions of the frame or packet produced by the encoder. In other words, the coding scheme used to encode an original content file to create compressed packet 108 to begin with involved changing bit positions of original bits, adding bits, and otherwise changing bits. Now, by puncturing the compressed packet, some of these bits are removed and the file compressed, and the known sequence of bits has been destroyed in the resulting Rx DATA TABLE 112 as well as any means to determine what data is missing or where the missing data should be inserted during decoding. For example, when attempting to decode the file used for FIG. 29A, some bits which should have appeared in a later frame are now misunderstood to appear in an earlier frame, effectively overwriting the actual (now missing) bits. This happens repeatedly, which effectively makes the DTF useless in trying to regenerate the original audio content file.

### Customized EBT Channel Services

As noted above, there are different types of decoder table file libraries. In one implementation, the decoder table files stored locally can be common to a large population of radios or receivers (e.g., for long duration or short duration EBT channel service as illustrated in FIGS. 25 and 26) such that one or more broadcast signals or “channels” containing the corresponding transmitted EBT files (e.g., BTFs) can be created, transmitted to all of the radios and have all of the listeners receive the same content at the same time. In this implementation, each radio having the same set of decoder table files receives the same set of channels and the experience is similar to other broadcast services, although with less bandwidth required. In a different implementation, the decoder table files stored locally are wholly or substantially customized for individual subscribers such that a custom stream may be created containing a sequence of transmitted EBT files (e.g., BTFs) for each individual subscriber.

Support for Custom EBT channels can be accomplished with a software application (i.e., an “App”) running on any one of a number of wirelessly connected multi-purpose devices such as a communication device or portable computing device, including but not limited to a smart phone, tablet, or personal navigation device, or it could be accomplished with a radio device that also receives broadcast transmissions from satellite or terrestrial sources.

In this implementation, a user can specify favorite artists and/or songs, and a corresponding baseline decoder table library is then loaded on the radio device. Alternatively, the user can chose from among several preset baseline libraries. Subsequent to the initial decoder table library installation, a custom stream is then created using only content in the custom decoder table library. While listening to this custom stream, the user can indicate approval or disapproval for the currently playing content, and this approval or disapproval feedback then triggers the download of additional decoder table files, as well as the removal of stored decoder table files. The listener would have a user experience similar to other customized streaming music services; however, the bandwidth used for streaming would be substantially reduced since repeats of individual songs would require only the transmission of the BTF or streaming file. In this implementation, updates to the decoder table files could be preferentially performed over a WiFi or other “free” connection, while the streaming listening experience could take place over a wireless network (3G, 4G etc.) that charges by the amount of bandwidth used. An example cellular streaming application is described below.

It is thus noted that the various EBT techniques described above can be applied in a variety of ways to both support, and optimize bandwidth usage for, transmission of audio content to a user in a personalized music service. In sophisticated embodiments of such personalized music services, complicated cross-fades and other interstitial effects are performed to give a user a full “broadcast experience” on his or her smartphone, tablet or other intelligent mobile device. In order to facilitate such complex cross-fades, including those utilizing multiple elements, the relevant audio files and interstitials, along with detailed instructions as to how to implement the cross-fade (e.g., the audio trajectory, timing, intro and outro information, etc.) can be present to the user's device. This process is dynamic, and what is present, as well as how long before the actual cross-fade is implemented is it present, is a function of numerous metrics, including bandwidth, available memory on the user device, then present network conditions, etc., all of which can be processed, for example, by an intelligent download manager. In exemplary embodiments of the present invention, this download manager can be configured to include file splitting of encoded audio files and sending them in two or more files as described hereinabove, to optimize the use of often precious bandwidth and on-device memory to presend the vast majority of the audio content to such user devices. Details of such systems and methods, and the various considerations in presending elements of complex cross-fades and other effects are described in U.S. Provisional Patent Applications Nos. 61/631,440, filed on Jan. 3, 2012, and 61/561,593, filed on Nov. 18, 2011, each entitled “Systems and Methods for Implementing Cross-Fading, Interstitials and Other Effects/Processing of Two or More Media Elements Downstream,” and the corresponding PCT patent application, PCT/US2012/065943, filed on Nov. 18, 2012. These provisional patent applications, and the PCT patent application claiming priority to them, are under common assignment herewith, and are hereby fully incorporated herein by reference.

### EBT Cellular Streaming Application

In accordance with an illustrative embodiment of the present invention, EBT can be used to leverage data stored at a mobile phone to achieve a cellular streaming system that reduces data consumption (e.g., data service plan bits) and power consumption at the smartphone, while also realizing the above-described advantages of increased bandwidth efficiency in the content delivery systems providing the streamed content. As noted above, EBT channels can be transmitted via satellite service such as the SDARS currently available in the United States and Canada; however, EBT channels can also be distributed via cellular services which are available world-wide. Also, as noted above, using EBT reduces music streaming rates to about 3 kbps, realizing a significant advantage over existing music streaming services that use 32 kbps, 64 kbps or higher. This reduced rate provides measurable advantages for smartphone users since data plan loading for streaming music is reduced by greater than 90%. Further, modem power consumption for streaming music may be reduced. Such EBT advantages can also be extended to other platforms such as a data load audio service via a telematics platform.

By way of an example, a smartphone can be configured with 32 GB flash reserved for EBT, which may be partitioned to contain a 30 GB song library loaded at manufacture (e.g., about 45,000 songs) and 2 GB for library updates (e.g., about 3,000 songs). If EBT were implemented to deliver an existing streaming service, for example, the song library can be specified based on the song usage statistics for that service. Library IDs as described above can be used to identify the library contents stored at manufacture.

The EBT streaming service can include, for example, as many as 100 streams programmed based on the device library ID. New songs can be downloaded based on user preferences, as described above. The streaming content service engine maintains a unique library per user or subscriber, and therefore maintains knowledge of what is in a user's library to stream selected content (e.g., custom-curated content based on user preferences indicated by content requests, rewinds, skips, and other user content interactions via the two-way interface) via corresponding transmitted EBT files (e.g., BTFs) with certainty that the user device stores the necessary DTFs for EBT decoding as described above. More specifically, custom EBT channels can be created with two-way transmission systems (e.g., using a smartphone or internet radio or other internet device). This example applies to music but is understood to be applicable to other types of streamed media. A user provides a profile to a music server or other content server, for example, that in turn selects suggested content (e.g., 500 songs) based on that profile. The songs are prepared for delivery to users by encoding and splitting them into EBT files (e.g., BTFs and DTFs as described above in connection with FIGS. 1 and 2). EBT file splitting can be performed in advance of user requests for that content and the respective files (e.g., BTFs and DTFs) stored, for example, to generate different baseline or custom decoder table libraries to store at user devices and then corresponding streams of files when requested. A custom library of DTFs corresponding to those songs is provided to the user's smartphone or internet device. For example, the user can receive and store the library of DTFs when the user has a WiFi connection. When the user is streaming the suggested content, the corresponding BTFs are streamed to the smartphone or internet device at a low bit rate afforded by EBT. The smartphone or internet device is configured (e.g., via an EBT App) to combine the BTFs with corresponding DTFs in the received custom library.

Since receiving the BTFs at a smartphone consumes a comparatively small amount of service minutes, streaming content providers have incentive to offer more streaming services. A streaming service would benefit from commercial free radio streams generated using EBT, in addition to the improved bandwidth efficiency and opportunity to offer more services. Further, EBT can be employed to deliver a custom-curated streaming service.

### Implementing Updates to a Locally Stored EBT File

As described above in connection with FIGS. 11, 12, 13, 14A and 14B, the locally stored file table can be updated in several ways: in a first method the stored table file is completely over-written with a new stored table file (i.e., the old table is deleted or erased and a new table having the same index is stored in its place). In the first method, the new file table may (a) contain none, some, or all of the decoder table files that were in the table that it replaced, (b) may use different audio encoding techniques, (c) may utilize a different file-splitting method and/or different file splitting ratio, or may (d) use the same encoding technique at a different encoded bitrate. In a second method, the stored file table or decoder table library is modified by (a) the deletion of one or more single decoder table files leaving the other contents of the stored library unmodified, (b) the addition of one or more decoder table files leaving the other contents of the stored library unmodified, or (c) the replacement of one or more files in the stored library with one or more corresponding new files, resulting in a new stored decoder table library having some of the old content and some new content. In the second method, the additional or replacement tracks must use the same audio encoding method, file splitting technique, and encoding rate as the other decoder table files.

As an example, a currently stored library or libraries can be replaced or a new library or libraries added by distributing a physical storage medium such as solid state memory device (SD, SDHC, and the like) or an optical disk that is provided to the receiving device. As stated above, a library or libraries can also be replaced or updated using a broadcast transmission channel and a non-real-time file distribution method. When updating, substantial amounts of a library generally remain unchanged, while individual files can be removed and others added. Alternatively, a library or libraries can be updated or modified using a two-way wired or wireless internet connection (e.g., to produce a custom decoder table library or libraries), whereby substantial amounts of a library would generally remain unchanged while individual files can be removed and/or added.

### Illustrative EBT Service Distribution Systems

As described above, in the case of a SDARS provider or similar content provider, the transmitted EBT file (e.g., BTF) can be part of a program content stream comprising other content (e.g., a SDARS broadcast stream generated at the programming center 20 in FIG. 1). The broadcast stream or other transmission mode for the file can, for example, constitute 10 percent of the file content, while the remaining 90 percent of the file content is represented in decoding files or data structures stored at the receivers, to significantly increase the efficiency of the transmission mode. Other splitting ratios for the two files could be used provided that the larger of the file had enough information removed so as to make the resulting file unplayable in a form that was recognizable as the original audio content.

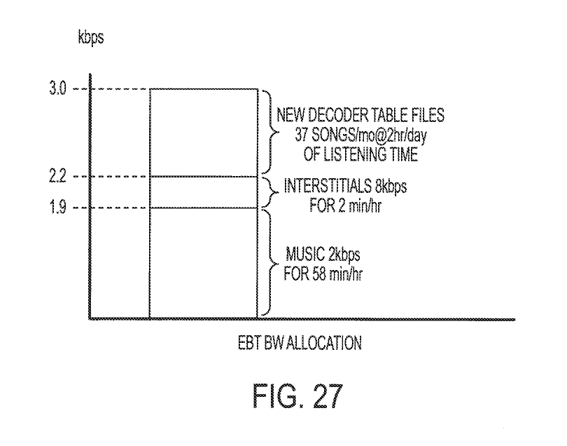

In accordance with illustrative, alternative distribution approaches, one of the file tables can be sent to the receiver 14 over a wireless data network (e.g., a 3G or 4G network) as a data stream rather than as a broadcast stream. Alternatively, one of the file tables can be sent over an internet protocol (IP) network (e.g., wired or wireless). In another alternative distribution approach, both files can be streamed but using different repeat frequencies, transmission rates, or transmission protocols, with the larger file (e.g., DTF) getting less frequent updates using a non-real-time data caching distribution method, and the smaller file (e.g., BTF) being sent in real-time on a scheduled basis as part of a channel stream or on-demand. For example, as shown in FIG. 27, a 3 kbps stream can be partitioned such that 1.9 kbps was used for real-time streaming of EBT content (e.g., music at 2 kbps for 58 minutes/hr., another 0.3 kbps could be allocated for 8 kbps interstitial material for 2 minutes/hr. that can be stored and inserted to fill gaps in streaming playback, and the remaining 0.8 kbps can be used to update the decoder table libraries (e.g., new music tables such 37 songs/month using about 2 hrs./day). In an IP streaming implementation of this embodiment, the new decoder table updates can be customized based on the preferences of the listener (e.g., using existing software that compares metrics of consumed content such as tempo, content style and so on with that of online content service catalogue to automatically select suggested update content). The broadcast infrastructure can then maintain a unique library for each listener and create unique real-time streams corresponding to each listener's library.

Alternatively, a library or set of libraries can be stored on a flash memory device such as USB thumbdrive or micro SD card (or micro SDHC or SDXC card) and sold at a retail establishment. Alternatively, a library can be customized in real-time for a particular subscriber by the addition or removal of decoder table files in response to feedback from the listener (“like”/“dislike”). The approach in which both files are transmitted, but at different rates over different transmission channels is ideally suited to a video application in which a multiplicity of popular video files (e.g. television shows or movies) are downloaded (“pushed”) to a receiving device over a low-cost data channel and then the smaller file is either streamed in real-time if the user chooses to purchase the rights to watch the content, or is downloaded in its entirety if the user chooses to purchase the rights to permanently store the content. In another example of such an implementation, a database containing data corresponding to networks of roads, points of interest, bus schedules, restaurant reviews and other useful information could be compressed with an entropy coding technique and the resulting encoded database file could then be split into two parts using EBT such that the larger of the two parts could be transmitted using a non-real-time data caching distribution method or even embedded in an informational “App” that could be distributed for free or at low cost, while the smaller file could be transmitted rapidly on-demand to customers that pay an additional fee for the updated database functionality.

### EBT-Enabled Pay-as-Consumed Business Models for Content Delivery

The efficient transmission bandwidth afforded using EBT files for content delivery enables users to request and download significant amounts of video content (e.g., television programs, movies, videos) that most likely exceeds the amount of time the user has to watch the content. The use of EBT files, however, provides a convenient means to structure pricing plans to meet the various degrees to which the user actually consumes the requested content.

For example, a network-connected device can be used to allow a user to view menus and schedules of available content and to request and download DTFs for selected content (e.g., television programs, movies, videos). As described above, the DTFs can be downloaded or received via broadcast. For example, a content provider or distributor such as Amazon can configure and send a personalized library of DTFs based on user requests. The corresponding BTFs are then only streamed when the user has requested to watch a particular program from the selected content. Thus, a base fee can be charged to request and store DTFs of prospective programming content, and an extra fee can be charged per real-time or near real-time consumption as BTFs are received for a program in volatile memory on a per-view basis. Finally, the user device can be configured with built-in logic to trigger a payment process to download and store a program in non-volatile memory. Multiple transmitted EBT files corresponding to the requested content can be buffered as described above to enable the user to skip among them. EBT content can therefore be decoded and enjoyed (e.g., a favorite video or song) while a user waits for another live content stream to be buffered (e.g., when the connection is too slow) for playback.

In another illustrative business model, DTFs for a particular service or application (e.g., a navigation service or data application) can be preloaded onto devices, and the devices therefore distributed with essentially a non-working data file to implement the service or application. For example, the DTFs can be for a raw database file needed to implement a service that users may or may not elect to activate when they acquire the device. In the event the user desires the service, the missing data needed to make the stored data file operational can be sent via a reduced bandwidth EBT file (e.g., BTF).

### Fading Profiles/Attenuation Masks

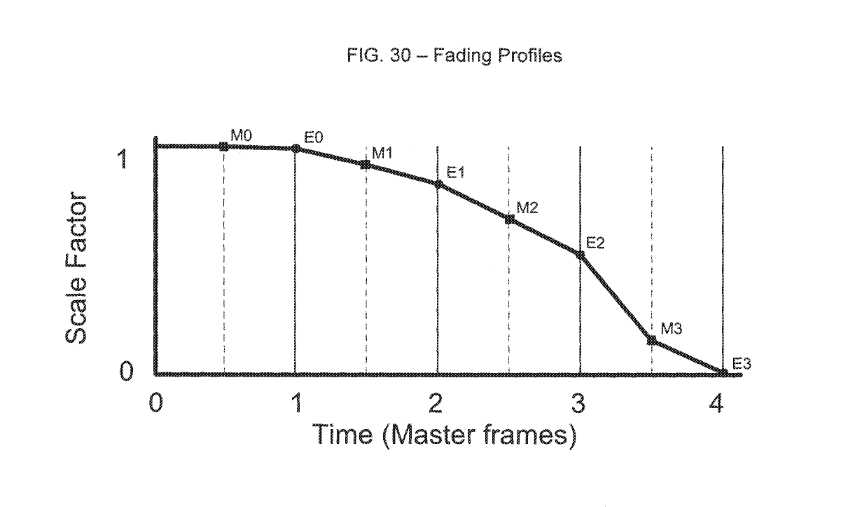

As noted above, in addition to sending audio clips via EBT that allow a series of songs, for example, to be played at a receiver, interstitials may also be sent which may be played between two songs. In addition, to perform fade-in, fade-out and cross-fading functions, a segmented attenuation mask can, for example, be sent in a packet header. For example, for each master frame, the attenuation for the 5^{th} audio frame (mid-master frame) and the last audio frame can, for example, be transmitted in the packet header. A linear fade is applied between the end attenuation of the previous frame and the mid attenuation of the current frame. The same between mid and end attenuation for the current frame. FIG. 30 shows an example fade-out attenuation mask over 4 frames.

For the beginning of the track or channel change, an initial attenuation needs to be implied, since there is no end attenuation from the previous frame. In these cases, the following Table 2 can, for example, be used to provide implied previous end attenuations.

TABLE 2
Attenuations For Packet Scenarios Within A Given Stream Slot

| Case | Condition | Previous End Track Attenuation |
|---|---|---|
| 1 | Mid Attn = End Attn | Current Mid-Attenuation |
| 2 | Mid Attn > End Attn | No Attenuation (Scale Factor = 1) |
| 3 | Mid Attn < End Attn | Full Attenuation (Scale Factor = 0) |

### Library Formats and Stream Protocol; Decoder Process

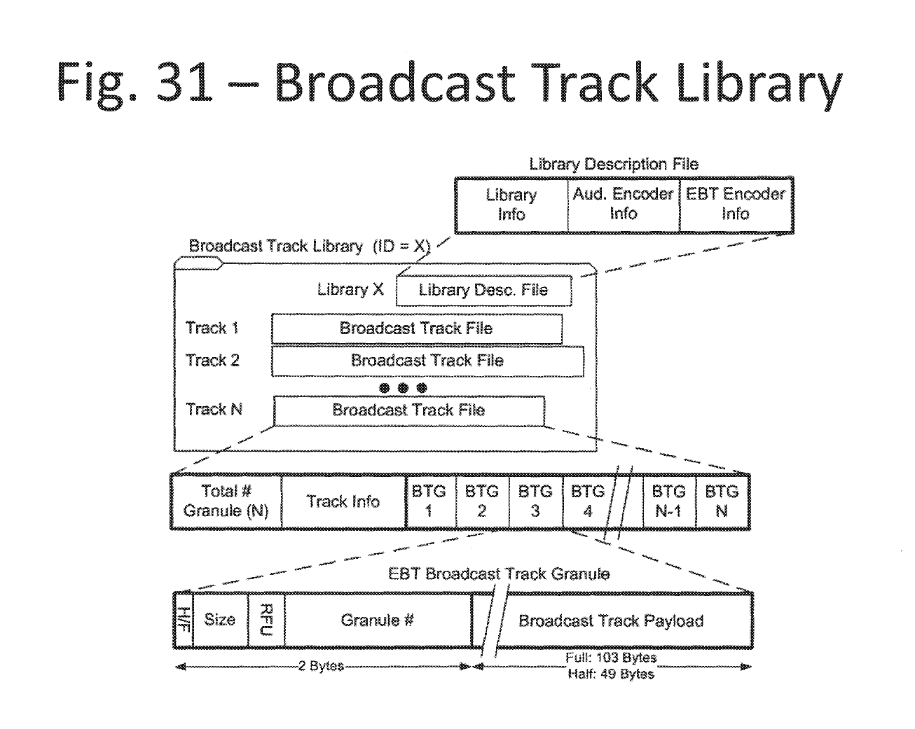

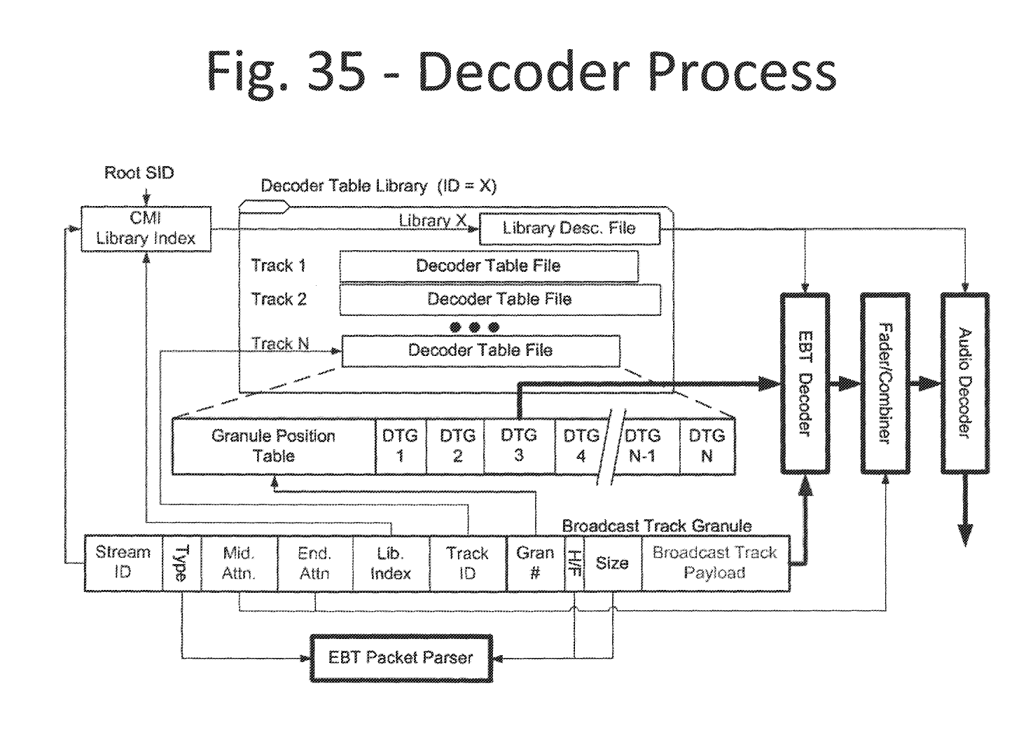

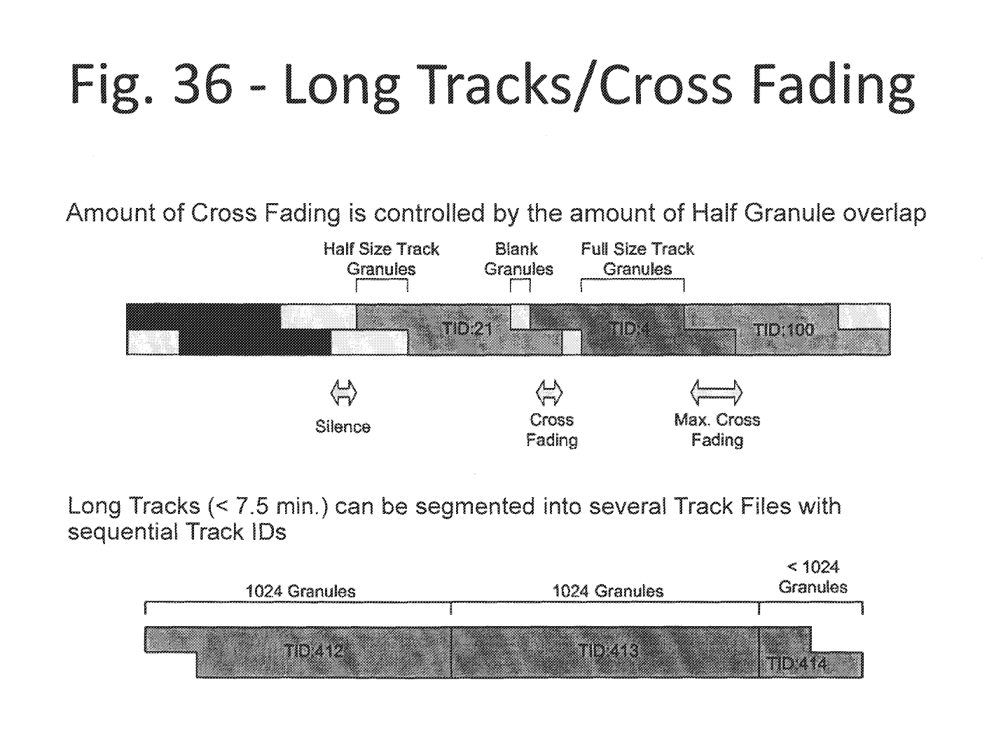

FIGS. 31-34, next described, illustrate exemplary library formats, packet structures, and stream protocols that may be used for Broadcast Track Libraries, Decoder Table Libraries, and EBT packets in accordance with various exemplary embodiments of the present invention. FIG. 35 illustrates an exemplary decoder process, and FIG. 36 illustrates cross-fading options and splitting of long tracks, according to various exemplary embodiments of the present invention.

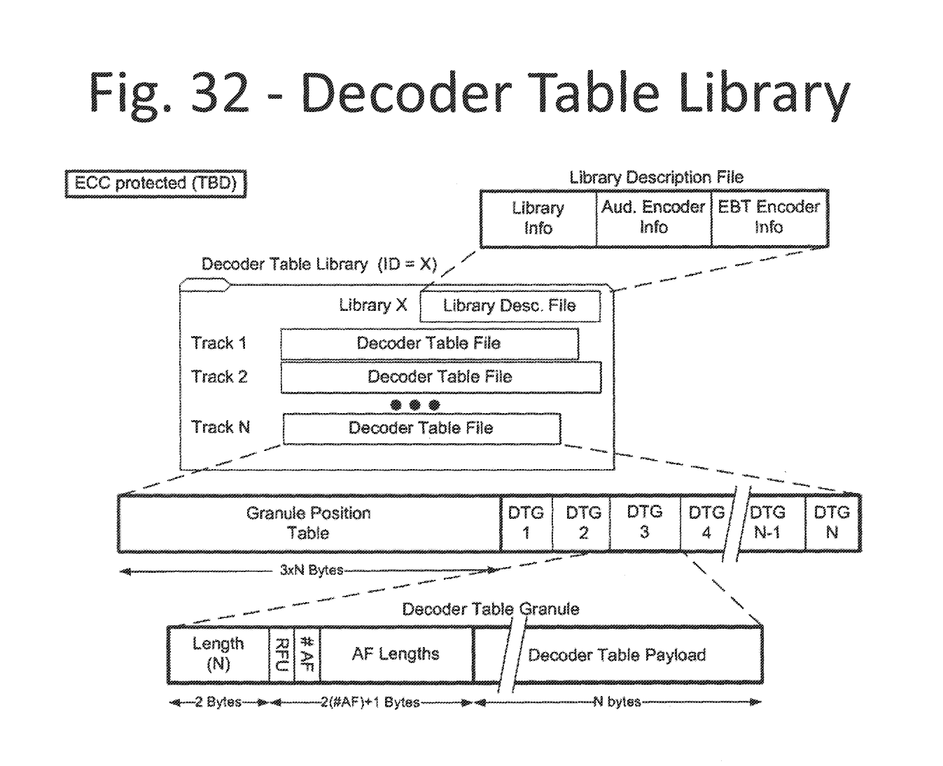

As noted above, in exemplary embodiments of the present invention, a set of broadcast table files can be sent over the air to receivers. The receivers may be pre-loaded with a set of decoder table files, or have otherwise stored such files, for example, via an over the air update, via a satellite communications path, or for example, via a cellular network communications path. Each of these sets of files can be organized as a library. The first one, the library of BTFs, may be stored on an uplink device ready to be sent over the air, and the other, the DTFs, stored on receivers. FIGS. 31 and 32, respectively, thus show exemplary structures for Broadcast Track Library and a Decoder Table Library. Although self-explanatory, with reference thereto, the following points are noted. In a Library Description File, shown at the upper left of each of these figures, an “Audio Encoder Info” field can provide information as to which type of encoding was used on the original audio files, such as, for example, USAC, AAC+, etc. Similarly, an “EBT Encoder Info” field can provide information as to what puncturing scheme was used, to allow decoding on the receiver end. As can be seen in FIGS. 31-32, each of the BTFs and DTFs are ultimately composed of “Granules.” With reference to the detail of the Granule structure shown on the bottom of each figure, the following is noted. The field “RFU” stands for “reserved for future use” and is thus, in the examples of FIGS. 31 and 32, a blank field. The field “H/F” in FIG. 31 contains information as to whether the Granule is half size or full size, and the field “AF Lengths” indicates the length of the relevant audio frames, which is useful information when using an audio encoder that outputs variable length frames. As shown in the top left of FIG. 32, the DTF files, which are resident on a receiver, for example, can be error correction code protected, for example.

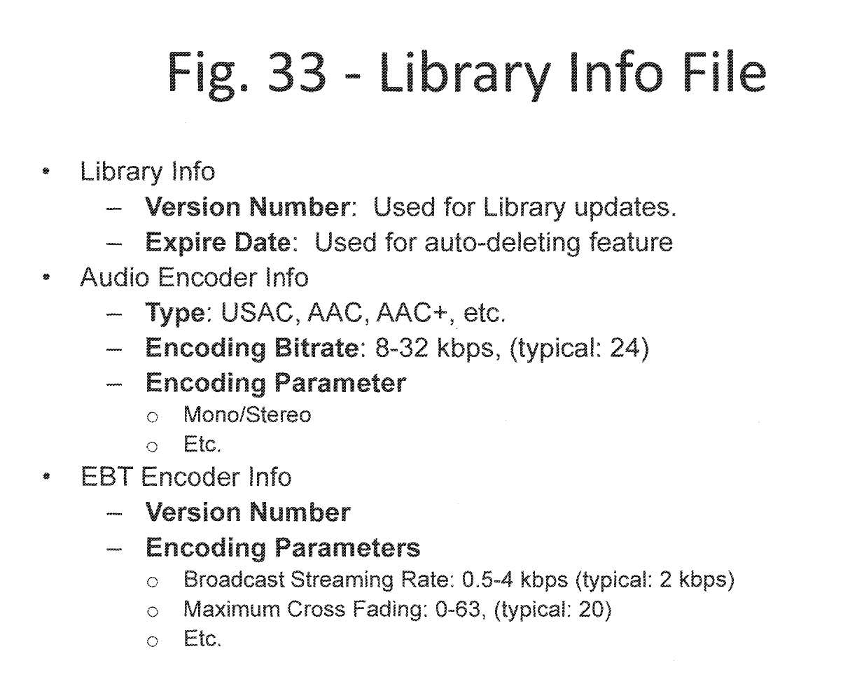

FIG. 33 illustrates exemplary contents of an example “Library Info” field, which is a first field shown in the Library Description File of FIGS. 31 and 32, as noted above.

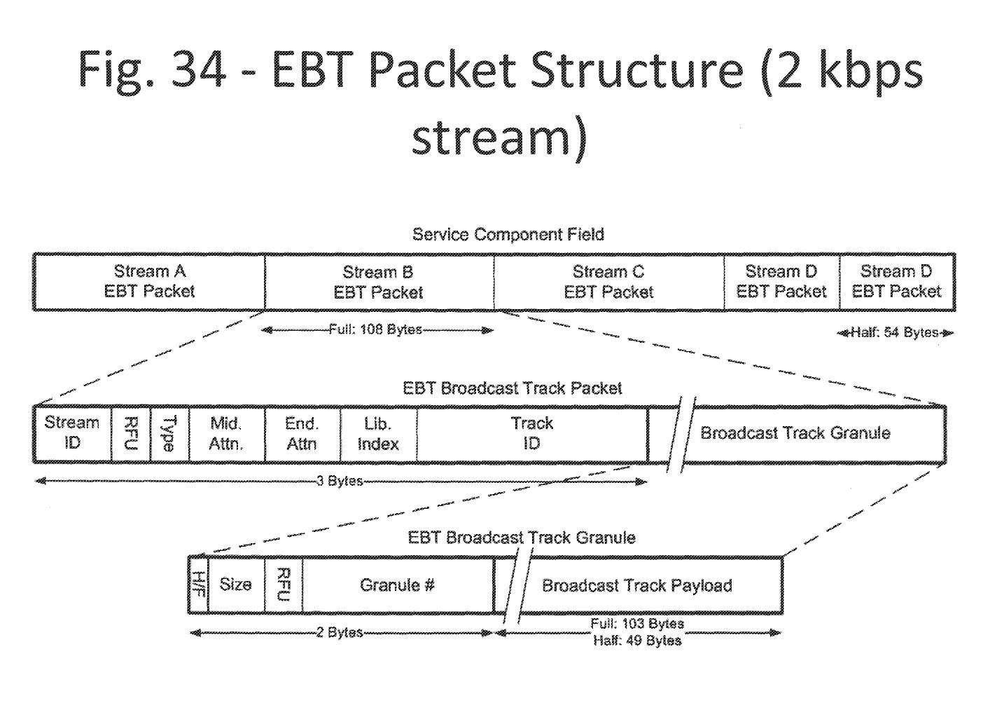

FIG. 34 illustrates an exemplary EBT packet structure, for use in a 2 kbps stream. Noteworthy here is the structure of an EBT Broadcast Track Packet, which includes attenuation values for each of mid and end attenuations. These may be used as described above, in connection with FIG. 30, to perform fade-in, fade-out and cross-fading functions. These values thus comprise an exemplary segmented attenuation mask sent in the packet header, here 3 bytes in total, and where the mid attenuation and end attenuation fields can each have, for example, 4 bits.

FIG. 35 illustrates an exemplary decoder process, by which various Decoder Table Files, as shown in FIG. 32 (within the Decoder Table Library), are combined with corresponding Broadcast Track Files, as shown in FIG. 31 (within the Broadcast Track Library), in an exemplary EBT Decoder. The shown “Root SID” is a root or base stream identifier, which, when combined with the SID, or stream identifier, and a Library Index, all obtained from a received Broadcast Track Granule, which is an element of a Broadcast Table File, as shown in FIG. 31, obtains the correct library index within the Decoder Table Library, and thus determines the proper corresponding Decoder Table Granule, as shown. The two corresponding Granules are then input to the EBT Decoder, whose output is then input to the Fader/Combiner, whose output is input to the Audio Decoder, to obtain the final output.

Finally, FIG. 36 illustrates how cross-fading may be controlled via the amount of overlap of half granules, and also illustrates how Long Tracks, e.g., those having greater than 7.5 minutes of audio signal, may, for example, be segmented into several Track Files, each having sequential Track IDs.

Illustrative embodiments of the present invention have been described with reference to operations at a programming center or similar content source, and receivers or other user devices. It is to be understood, however, that the present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, DVDs, magnetic tapes, floppy disks, optical data storage devices. It is envisioned that aspects of the present invention can be embodied as carrier waves (such as data transmission through the Internet via wired or wireless transmission paths). The computer-readable recording medium can also be distributed over network-coupled computer systems so that the computer-readable code is stored and executed in a distributed fashion. Also, functional programs, codes, and code segments for accomplishing the present invention can be easily construed as within the scope of the invention by programmers skilled in the art to which the present invention pertains.

While the invention herein disclosed has been described by means of specific embodiments and applications thereof, numerous modifications and variations can be made thereto by those skilled in the art without departing from the scope of the invention.

What is claimed is:

1. A method of increasing transmission bandwidth when delivering content, comprising:
generating at least two files comprising a decoding file and a transmitted file for each of a plurality of content files by encoding and dividing each of the encoded content files among its corresponding decoding file and transmitted file;
providing the decoding files to a receiver;
generating a stream using the transmitted files;
sending the stream to the receiver such that each transmitted file in the stream is sent to the receiver after its corresponding decoding file has been provided to the receiver; and
decoding the transmitted files using the stored decoding files as the stream is received.

2. The method of claim 1, further comprising generating a program channel using a selected sequence of the transmitted files for generating a stream to deliver the program channel.

3. The method of claim 1, further comprising grouping the corresponding decoding files in memory as a library, and providing instructions to the receiver to retrieve the decoding files from the library when decoding the transmitted files in the program channel.

4. The method of claim 1, further comprising grouping the decoding files in memory as a library with encoding information that is common to each of the decoding files in the library, the encoding information comprising at least one of encoder type, encoded bit rate, and file-splitting method.

5. The method of claim 1, further comprising:
grouping the decoding files in at least two libraries having respective library identifiers;
providing at least one of the libraries to the receiver;
generating a plurality of program channels using respective libraries;
sending the plurality of program channels to the receiver via one or more streams; and
providing instructions to the receiver on which of the libraries to use for decoding a received stream depending on the currently tuned program channel.

6. The method of claim 5, wherein providing the instructions to the receiver comprises one of embedding the instructions in the transmitted file and adding the instructions as a wrapper to the transmitted file when transmitted, the instructions comprising at least one of a library identifier corresponding to the transmitted file and a file index.

7. The method of claim 5, further comprising providing a receiver with a table identifying, for each of the program channels, the library identifiers used to generate the respective program channels.

8. The method of claim 5, further comprising updating the libraries stored at the receiver via at least one of adding a new library, deleting a library and updating an existing library using a different version of the existing library, wherein the updated library employs the library identifier of the existing library and a version indicator.

9. The method of claim 8, further comprising providing one or more libraries to the receiver via at least one of a removable storage medium, and transmission using one at least one of a wired communication link and a wireless communication link.

10. The method of claim 5, wherein the at least two libraries comprises a short duration channel service library comprising a grouping of decoding files that is changed, and further comprising transmitting the decoding files in the short duration channel service library to the receiver for a selected period of time during which the receiver needs receive time to obtain a complete short duration channel service library with which to play content on a short duration service channel generated using the short duration channel service library.

11. The method of claim 10, wherein the at least two libraries comprises a long duration channel service library comprising a grouping of decoding files that is not changed and that is pre-stored in the memory, and further comprising transmitting a mixed channel service to the receiver comprising a plurality of program channels based respectively on the long duration channel service library and at least one short duration channel service library.

12. The method of claim 11, wherein the transmission bandwidth profile comprises transmission bandwidth designated for the plurality of program channels and transmission bandwidth allocated for transmitting short duration channel service libraries.

13. The method of claim 12, wherein the transmission bandwidth profile comprises transmission bandwidth designated for interstitial content for insertion into the plurality of program channels, and further comprising dynamically changing allocations of transmission bandwidth designated to transmit the short duration channel service libraries and the plurality of program channels to manage increases in instantaneous bandwidth occurring when several of the program channels play interstitial content at once.

14. A method of increasing transmission bandwidth when delivering content, comprising:
generating at least two files from a content file by encoding and dividing the encoded content file among a decoding file and a transmitted file, the decoding file being a denatured file;
providing the decoding file to a receiver and storing in a memory in advance of receiving the transmitted file;
sending the transmitted file to the receiver; and
generating a decoded file at the receiver using the transmitted file and the stored decoding file.

15. The method of claim 14, wherein the decoding file is one of lightly denatured, moderately denatured, and denatured such that no part of the content file can be determined without the transmitted file.

16. The method of claim 14, wherein the decoded file is generated as the transmitted file is received in one of real-time and near real-time.

17. The method of claim 15, further comprising:
generating at least two files comprising a decoding file and a transmitted file for each of a plurality of content files by encoding and dividing each of the encoded content files among its corresponding decoding file and transmitted file, the decoding file being a denatured file;
providing the decoding files to a receiver and storing in a memory in advance of receiving the transmitted files;
generating a stream using the transmitted files;
sending the stream to the receiver; and
decoding the transmitted files using the stored decoding files as the stream is received.

18. The method of claim 17, further comprising assigning an index to each transmitted file and its corresponding decoding file for locating a decoding file in the memory when its corresponding transmitted file is received, and providing the index for each of the transmitted files in the stream and the index for each of the stored decoding files to the receiver.

19. The method of claim 17, where the plurality of content files comprises a type of content selected from the group consisting of audio, video, data, static image and a combination of two or more of these types of content.

20. The method of claim 14, wherein the content file is a type of content selected from the group consisting of audio, video, data, and static image.

21. The method of claim 20, further comprising providing encoding information with the decoding file for storing in the memory, the encoding information comprising at least one of an encoder type, an encoded bit rate, and a file-splitting method.

22. The method of claim 20, further comprising providing encoding information with the transmitted file by one of embedding the encoding information in the transmitted file and adding the encoding information as a wrapper to the transmitted file when transmitted, the encoding information comprising at least one of an encoder type, an encoded bit rate, and a file-splitting method.

23. The method of claim 21, wherein generating the encoded content files comprises generating a plurality of corresponding segments in the transmitted file and the stored decoding file, and further comprising sending the encoding information in each of the segments in the transmitted file.

24. The method of claim 14, wherein generating the encoded content files comprises generating a plurality of corresponding segments in the transmitted file and the stored decoding file that can each represent one or more segments in the content file, the segments having segment identifiers for matching the segments in the transmitted file to the corresponding segments in the stored decoding file.

25. The method of claim 24, wherein the segments vary in length.

26. The method of claim 14, wherein generating the encoded content files comprises providing a majority of the content file in the stored decoding file, and sending the transmitted file employs a communication link for which transmission bandwidth is optimized more relative to any transmission bandwidth employed when providing the decoding file to the receiver.

27. The method of claim 14, wherein sending the transmitted file employs at least one of a broadcast, streaming, a unicast, a multicast, a wireless transmission, transmission via wired network, a digital audio broadcast (DAB) system, a high definition (HD) radio system, an FM radio system, a Direct-to-home satellite video system, a cable television system, a two-way internet protocol (IP) system, a mobile communication system, and an on-demand content delivery system.

28. The method of claim 14, wherein providing the decoding file to the receiver employs at least one of a broadcast, streaming, a unicast, a multicast, a wireless transmission, transmission via wired network, a digital audio broadcast (DAB) system, a high definition (HD) radio system, an FM radio system, a Direct-to-home satellite video system, a cable television system, a two-way internet protocol (IP) system, a mobile communication system, an on-demand content delivery system, and transfer to the receiver via a removable memory device.

29. The method of claim 14, wherein providing the decoding file to the receiver comprises at least one of pre-loading the receiver with the decoding file, sending the decoding file to the receiver prior to transmission of the transmitted file on a transmission link using either a different transmission link or the same transmission link but at a less efficient rate or off peak transmission time, downloading the decoding file from a network via Internet Protocol (IP) connection, a cached data push transmission, and a data pull transmission.

30. The method of claim 14, wherein the decoding file is stored in nonvolatile memory and the transmitted file is stored in volatile memory at the receiver when received for generating the decoded file.

31. The method of claim 14, wherein generating the decoding file and the transmitted file comprises puncturing the encoded content file and providing punctured bits in the transmitted file and remaining bits in the stored decoding file.

32. The method of claim 26, wherein generating the decoding file and the transmitted file comprises generating two asymmetric table files and providing the larger of the two asymmetric table files to the receiver as the stored decoding file.

33. The method of claim 14, wherein generating the decoding file and the transmitted file comprises generating polynomial product symbols from a matrix applied to respective segments in the content file, and transmitting a subset of the symbols in the transmitted file and providing the remaining symbols and matrix to the receiver.

34. The method of claim 14, wherein generating the decoding file and the transmitted file comprises locating information-dense parts of the content file, and placing the information-dense parts in the transmitted file.

35. The method of claim 17, wherein generating the encoded content files comprises reducing instantaneous transmission rate of beginning and end portions of adjacent transmitted files in the stream relative to a remaining portion of the files, and generating the stream comprises transmitting the end portion of a transmitted file overlapped with the beginning portion of an adjacent transmitted file.

36. The method of claim 35, wherein reducing instantaneous transmission rate comprises changing at least one of a rate and a ratio of the dividing in beginning and end portions of transmitted files in the stream relative to a remaining portion of the transmitted files to reduce bandwidth of the beginning and end portions.

37. The method of claim 35, wherein the overlapped portions comprise at least one of a crossfade between the adjacent transmitted files, and interstitial content inserted in the stream.

38. The method of claim 14, wherein at least one of a method, a rate and a ratio of the dividing varies depending on at least one of a type of the content file, a transmission link for transmitting the transmitted file, a period of storage designated for the decoding file, the size of the memory, and a performance parameter of the receiver to generate the decoded file.

39. The method of claim 17, wherein the decoding files are stored in nonvolatile memory, and the transmitted files are stored in volatile memory at the receiver when received for generating decoded files.

40. The method of claim 39, wherein the decoded files are stored and played back to a user from volatile memory.

41. The method of claim 40, wherein the decoded files are buffered and their playback controlled by user receiver operations selected from the group consisting of pausing, rewinding, fast forwarding and skipping buffered decoded files during one of real-time and near real-time decoding and playback.

42. The method of claim 39, wherein user rights to at least one of the decoded files are acquired and the acquired decoded file is stored in nonvolatile memory.

43. The method of claim 17, further comprising:
generating a plurality of program channels using different sequences of the transmitted files for generating streams to deliver the respective channels;
buffering the transmitted files in simultaneously received program channels; and
decoding and playing back a decoded file in a currently tuned program channel.

44. The method of claim 43, further comprising:
receiving an instruction to tune to a different program channel; and
decoding and playing back a decoded file in the different program channel.

45. The method of claim 43, wherein the buffered transmitted files are stored in volatile memory, and each decoded file is stored and played back to a user from volatile memory.

46. The method of claim 43, further comprising determining which of the buffered transmitted files to decode and playback based on user preferences and duration of the time the respective transmitted files shall remain buffered.

47. The method of claim 17, further comprising pausing the decoding of transmitted files as the stream is received, inserting interstitial content into the stream for playback, and resuming the decoding of transmitted files in the stream.

48. The method of claim 47, wherein resuming the decoding occurs after at least one of complete playback of the interstitial content and receipt of an instruction in the stream.

49. The method of claim 47, further comprising:
providing the interstitial content and a corresponding interstitial identifier to the receiver in advance of the inserting; and
transmitting control data in the stream indicating when the interstitial content is to be played back by the receiver.

50. The method of claim 49, wherein the interstitial content comprises a plurality of segments comprising multi-lingual segments, and regionally-targeted segments and targeted audience segments, and further comprising providing the receiver with instructions on which of the segments to insert.

51. A method of increasing transmission bandwidth when delivering content, comprising:
generating at least two files comprising a decoding file and a transmitted file for each of the selected content files by encoding and dividing each of the encoding content files among its corresponding decoding file and transmitted file, the decoding file being a denatured file from which no part of the content file can be determined without the transmitted file;
receiving a user request for selected content files and storing information about the selected content files;
providing the decoding files corresponding to the selected content files to a receiver for storage in a memory in advance of receiving the respective transmitted files; and
sending one or more of the transmitted files corresponding to the selected content files to the receiver for generating decoded files at the receiver using the received transmitted files and their corresponding stored decoding files.

52. The method of claim 51, wherein the received transmitted files and the decoded files are stored in volatile memory.

53. The method of claim 51, further comprising:
receiving a user input; and
modifying the decoding files stored at the receiver and the stored information about the selected content files in response to the user input.

54. The method of claim 53, wherein modifying comprises at least one of providing the decoding files corresponding to the different content files to the receiver for storage in the memory in advance of receiving their respective transmitted files, and sending instructions to the receiver to delete one or more of the decoding files stored at the receiver.

55. The method of claim 53 wherein the user input comprises at least one of a user profile provided by the user, and a user operation in response to the decoded file currently being playback back, the user operation being selected from the group consisting of skip, pause, rewind, fast forward, like, dislike.

56. The method of claim 51, wherein providing the decoding files to the receiver is via at least one of a WiFi connection, an IP connection, and a removable storage device, and sending the transmitted files is via a cellular communications service.

57. The method of claim 56, further comprising configuring a mobile telephone a programmed application to receive the transmitted files and generate the decoded files.

58. The method of claim 51, wherein the user request is for one or more of a plurality of pre-selected catalogues of contents, and further comprising providing the decoding files corresponding to each of the requested catalogues to the receiver in advance of receiving their respective transmitted files.

59. The method of claim 58, further comprising generating the pre-selected catalogues of contents using at least one of a user profile and content provider statistics.

60. The method of claim 51, wherein storing information about the selected content files comprises storing at least one of a user device library identifier, a user profile, and user preferences.

61. The method of claim 51, wherein a user views listings of content and scheduled programming via a network-connected device and designates prospective programming as the selected content files, and the corresponding transmitted files are sent to the receiver when the user elects to decode and playback one or more of the selected content files.

62. A non-transitory computer-readable medium storing a program for preparing content for delivery with increased transmission bandwidth, the program comprising:
a first set of instructions for selectively dividing an encoded content file among a decoding file and a transmitted file to create a denatured decoding file from which no part of the content file can be determined without the transmitted file; and
a second set of instructions for sending the decoding file to one or more receivers before sending the transmitted file to the one or more receivers.

63. The non-transitory computer-readable medium of claim 62, wherein the first set of instructions comprises instructions for dividing the encoded content file asymmetrically among the decoding file and the transmitted file to create a decoding file that is larger than the transmitted file.

64. The non-transitory computer-readable medium of claim 62, wherein the first set of instructions comprises instructions for generating a decoding file and a transmitted file for each of a plurality of content files by encoding and dividing each of the encoded content files among its corresponding decoding file and transmitted file, the decoding file being a denatured file from which no part of the content file can be determined without the transmitted file, and the second set of instructions comprises providing the decoding files to the one or more receivers in advance of sending the transmitted files to the one or more receivers.

65. The non-transitory computer-readable medium of claim 64, further comprising instructions for assigning an index to each transmitted file and its corresponding decoding file for locating a decoding file at the receiver when its corresponding transmitted file is received, and sending the index for each of the transmitted files with the transmitted file in a stream and the index for each of the stored decoding files to the one or more receivers.

66. The non-transitory computer-readable medium of claim 64, further comprising instructions for grouping the decoding files in at least two libraries having respective library identifiers and providing at least one of the libraries to the one or more receivers.

67. The non-transitory computer-readable medium of claim 66, wherein a plurality of program channels are generated using respective libraries and are sent to the one or more receivers, and further comprising instructions for sending information to the receiver relating to which of the libraries to use for decoding the transmitted files received via the program channels.

68. The non-transitory computer-readable medium of claim 64, further comprising instructions for sending control information to the one or more receivers to update one or more of the libraries.
